(19) United States
(12) Patent Application Publication
(10) Pub. No.: US 2020/0003448 A1
(43) Pub. Date: Jan. 2, 2020

(54) FACILITY MANAGEMENT PORTAL

(71) Applicant: Johnson Controls Technology Company, Auburn Hills, MI (US)

(72) Inventors: Alan S. Schwegler, Shorewood, WI (US); Paul Michael Nowak, Milwaukee, WI (US); Michael F. Kornacki, Oak Creek, WI (US); Ryan J. Bykowski, South Milwaukee, WI (US); Kierstyn R. Robbins, Waukesha, WI (US); Bridget E. Kapler, New Berlin, WI (US); Vineet Binodshanker Sinha, Brookfield, WI (US); Sayan Chakraborty, Brookfield, WI (US); Kerry M. Bell, Mukwonago, WI (US)

(21) Appl. No.: 16/453,280

(22) Filed: Jun. 26, 2019

Related U.S. Application Data
(60) Provisional application No. 62/690,899, filed on Jun. 27, 2018.

(51) Int. Cl. F24F 11/54; F24F 11/52; F24F 11/65

(52) U.S. Cl. CPC F24F 11/54; G06Q 50/163; F24F 11/65; F24F 11/52

(57) ABSTRACT

A facility management portal and associated user interface can be used for remote monitoring, servicing, and commissioning of a Building Management System (BMS) and associated devices. Building stakeholders can use the facility management portal to configure smart thermostat devices with various settings or parameters associated therewith. For example, building stakeholders may create device profiles associated with smart thermostat devices and provide different device profiles to different groups of thermostat devices installed in a building. Moreover, stakeholders can use the facility management portal to monitor data such as energy consumption and air quality associated with buildings. Building tenants can interact with control devices such as smart thermostats and associated mobile applications to initiate maintenance or emergency notifications relayed through the facility management portal.

### CROSS-REFERENCE TO RELATED PATENT APPLICATION

This application claims the benefit of and priority to U.S. Provisional Patent Application No. 62/690,899 filed Jun. 27, 2018, the entire disclosure of which is incorporated by reference herein.

### BACKGROUND

The present disclosure relates generally to a building control system, building automation system (BAS), or building management system (BMS). A building control system can include one or more control devices configured to generate and send control signals to building equipment such as HVAC equipment (e.g., chillers, air handling units, etc.), lighting, security systems, etc. Multi-function thermostats can be used as part of a building control system to present information to a user and to receive input from the user in addition to controlling building equipment. In some cases, several multi-function thermostats may be installed in a building and connected to the Internet.

### SUMMARY

One implementation of the present disclosure is a system including one or more computer-readable storage media having instructions stored thereon that, when executed by one or more processors, cause the one or more processors to implement operations. The operations include presenting a user interface to a user on a user device, the user associated with a building; displaying, on the user interface, a device profile interface including settings associated with a thermostat device, the settings including comfort settings, schedule settings, and notification settings for the thermostat device; creating a first profile for a first group of thermostat devices installed in the building based on a first input received from the user via the device profile interface, the first profile including comfort settings, schedule settings, and notification settings for the first group of thermostat devices; creating a second profile for a second group of thermostat devices installed in the building based on a second input received from the user via the device profile interface, the second profile including comfort settings, schedule settings, and notification settings for the second group of thermostat devices; providing the first profile to the first group of thermostat devices installed in the building for operation of the first group of thermostat devices in accordance with the first profile; and providing the second profile to the second group of thermostat devices installed in the building for operation of the second group of thermostat devices in accordance with the second profile.

Another implementation of the present disclosure is a method including presenting a user interface to a user on a user device, the user associated with a building; displaying, on the user interface, a device profile interface including settings associated with a thermostat device, the settings including comfort settings, schedule settings, and notification settings for the thermostat device; creating a first profile for a first group of thermostat devices installed in the building based on a first input received from the user via the device profile interface, the first profile including comfort settings, schedule settings, and notification settings for the first group of thermostat devices; creating a second profile for a second group of thermostat devices installed in the building based on a second input received from the user via the device profile interface, the second profile including comfort settings, schedule settings, and notification settings for the second group of thermostat devices; providing the first profile to the first group of thermostat devices installed in the building for operation of the first group of thermostat devices in accordance with the first profile; and providing the second profile to the second group of thermostat devices installed in the building for operation of the second group of thermostat devices in accordance with the second profile.

Yet another implementation of the present disclosure is a method including presenting a user interface to a user on a user device; displaying, on the user interface, a device profile interface including settings associated with a control device; creating a first profile for a first group of control devices associated with the building based on a first input received from the user via the device profile interface, the first profile including settings for the first group of control devices; creating a second profile for a second group of control devices associated with the building based on a second input received from the user via the device profile interface, the second profile including settings for the second group of control devices; providing the first profile to the first group of control devices associated with the building for operation of the first group of control devices in accordance with the first profile; and providing the second profile to the second group of control devices associated with the building for operation of the second group of control devices in accordance with the second profile.

### BRIEF DESCRIPTION OF THE DRAWINGS

FIG. 1 is a drawing of a building equipped with a HVAC system, according to some embodiments.

FIG. 2 is a drawing of multiple spaces and floors of the building of FIG. 1 equipped with control devices, according to some embodiments.

FIG. 3 is a block diagram of a waterside system that may be used in conjunction with the building of FIGS. 1-2, according to some embodiments.

FIG. 4 is a block diagram of an airside system that may be used in conjunction with the building of FIGS. 1-2, according to some embodiments.

FIG. 5 is a drawing of the control device of FIG. 2 and FIG. 4 along with various sensors and other associated components, according to some embodiments.

FIG. 6 is a diagram of a communications system located in the building of FIGS. 1-2, according to some embodiments.

FIG. 7 is a block diagram illustrating the control device of FIGS. 2, 4, and 5 in greater detail, according to some embodiments.

FIG. 8 is a drawing of a multi-function thermostat with a touch-screen display, according to some embodiments.

FIG. 9 is a drawing of an example equipment settings interface associated with a facility management portal that can be used to configure and manage the control device of FIGS. 2, 4, and 5, and 7, according to some embodiments.

FIG. 10 is a drawing of an example temperature settings interface associated with the facility management portal of FIG. 9, according to some embodiments.

FIG. 11 is a drawing of an example scheduling interface associated with the facility management portal of FIG. 9, according to some embodiments.

FIG. 12 is a drawing of an example display settings interface associated with the facility management portal of FIG. 9, according to some embodiments.

FIG. 13 is a drawing of an example building space configuration interface associated with the facility management portal of FIG. 9, according to some embodiments.

FIG. 14 is a drawing of an example device configuration interface associated with the facility management portal of FIG. 9, according to some embodiments.

FIG. 15 is a drawing of an example configuration interface associated with the facility management portal of FIG. 9, according to some embodiments.

FIG. 16 is a drawing of an example dashboard interface associated with the facility management portal of FIG. 9, according to some embodiments.

FIG. 17 is a drawing of an example search interface associated with the facility management portal of FIG. 9, according to some embodiments.

FIG. 18 is a drawing of an example calendar interface associated with the facility management portal of FIG. 9, according to some embodiments.

FIG. 19 is a drawing of an example air quality map interface associated with the facility management portal of FIG. 9, according to some embodiments.

FIG. 20 is a drawing of an example tenant summary interface associated with the facility management portal of FIG. 9, according to some embodiments.

FIG. 21 is a drawing of an example notification management interface associated with the facility management portal of FIG. 9, according to some embodiments.

FIG. 22 is a drawing of an example account management interface associated with the facility management portal of FIG. 9, according to some embodiments.

FIG. 23 is a drawing of an example device profile interface associated with the facility management portal of FIG. 9, according to some embodiments.

FIG. 24 is a drawing of another example device profile interface associated with the facility management portal of FIG. 9, according to some embodiments.

FIG. 25 is a drawing of another example device profile interface associated with the facility management portal of FIG. 9, according to some embodiments.

FIG. 26 is a drawing of another example device profile interface associated with the facility management portal of FIG. 9, according to some embodiments.

FIG. 27 is a drawing of another example device profile interface associated with the facility management portal of FIG. 9, according to some embodiments.

FIG. 28 is a drawing of an example location management interface associated with the facility management portal of FIG. 9, according to some embodiments.

FIG. 29 is a drawing of another example location management interface associated with the facility management portal of FIG. 9, according to some embodiments.

FIG. 30 is a drawing of an example quick commands interface associated with the facility management portal of FIG. 9, according to some embodiments.

FIG. 31 is a drawing of an example user management interface associated with the facility management portal of FIG. 9, according to some embodiments.

FIG. 32 is a drawing of an example reporting interface associated with the facility management portal of FIG. 9, according to some embodiments.

FIG. 33 is a drawing of an example user account interface associated with the facility management portal of FIG. 9, according to some embodiments.

FIG. 34 is a drawing of an example activity history interface associated with the facility management portal of FIG. 9, according to some embodiments.

### DETAILED DESCRIPTION

### Overview

Referring generally to the FIGURES, a facility management portal is shown, according to various embodiments. The facility management portal can be used with a building management system (BMS) and various control devices in order to create a user-friendly building ecosystem. A BMS may include control devices such as smart thermostat devices and sensors configured to collect a variety of data related to the building. Building tenants can interact with the control devices and BMS by interacting with a smart thermostat or by using a mobile application, for example. Building stakeholders can use the facility management portal for remote monitoring, servicing, commissioning, and configuring of the BMS and control devices.

### Building Management System

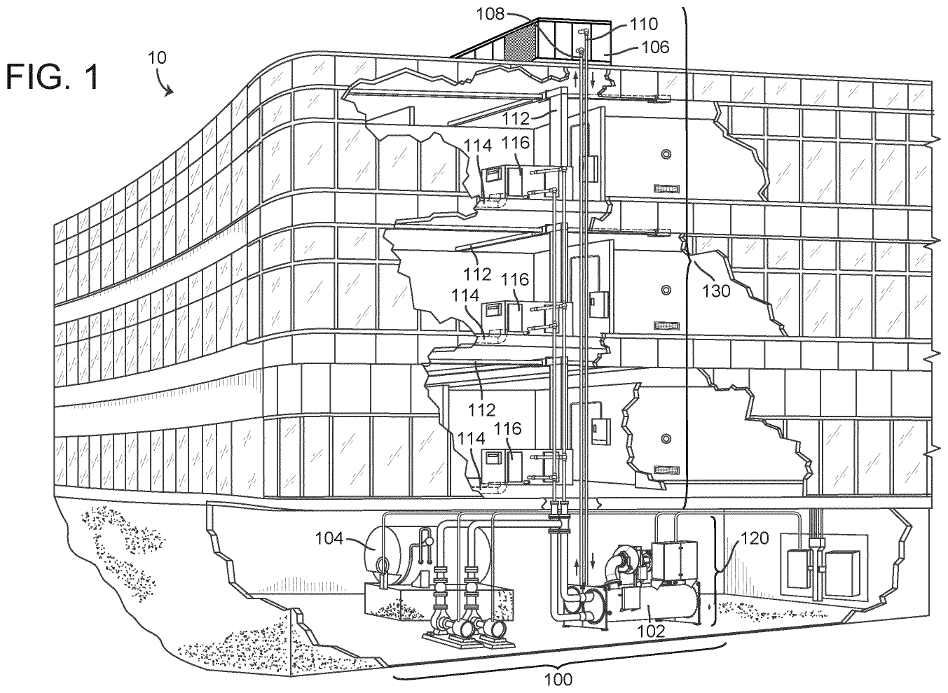

Referring now to FIGS. 1-4, an example building management system (BMS) and HVAC system in which the systems and methods of the present disclosure may be implemented are shown, according to some embodiments. Referring particularly to FIG. 1, a perspective view of a building 10 is shown. Building 10 is served by a BMS. A BMS is, in general, a system of devices configured to control, monitor, and manage equipment in or around a building or building area. A BMS can include, for example, a HVAC system, a security system, a lighting system, a fire alerting system, any other system that is capable of managing building functions or devices, or any combination thereof.

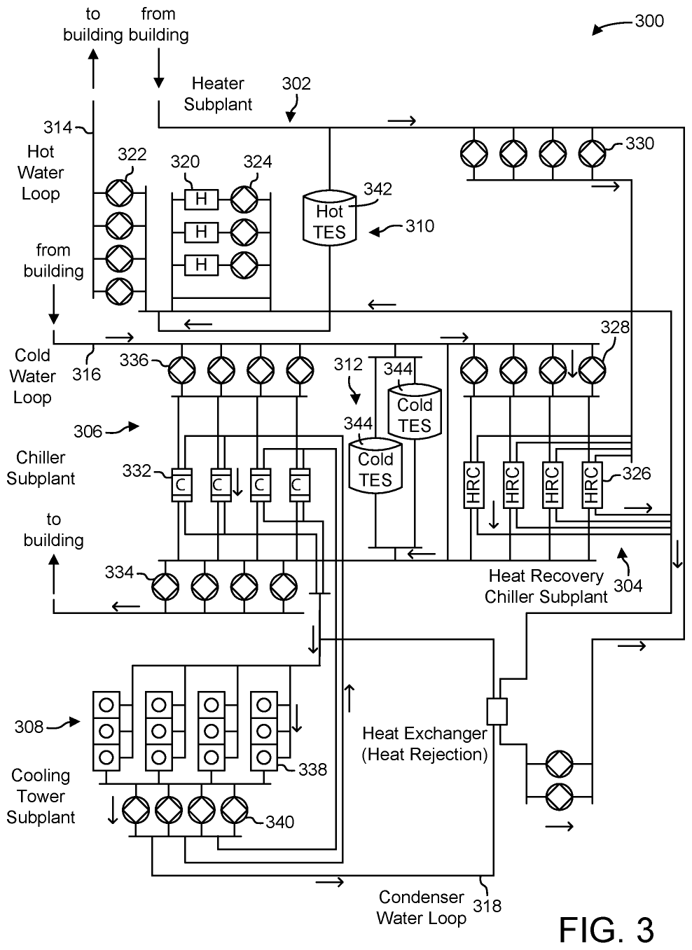

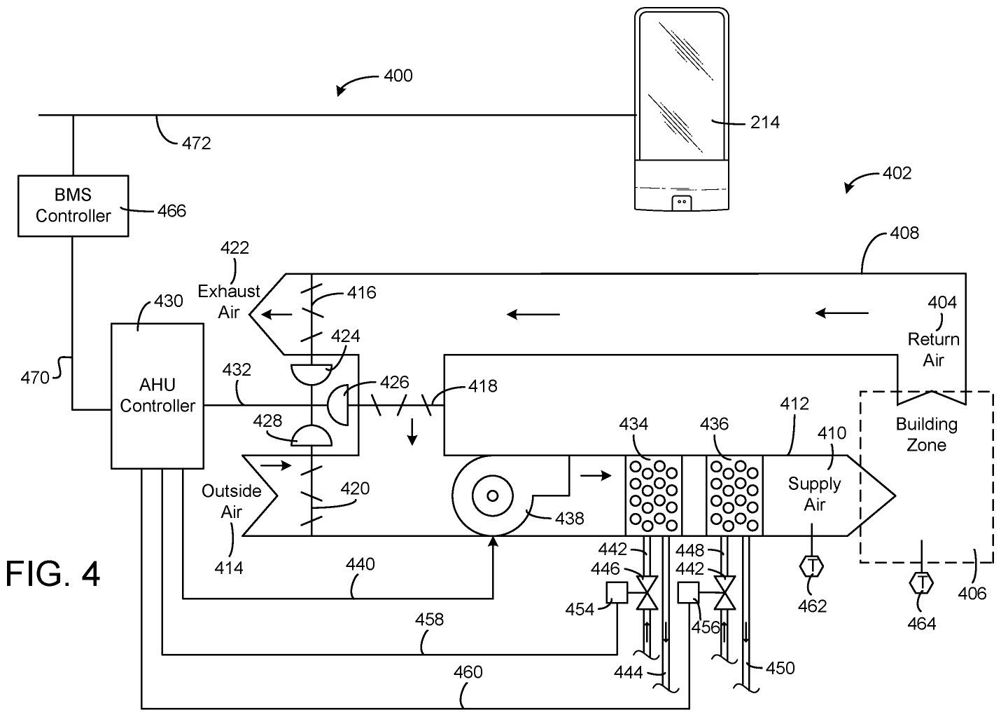

The BMS that serves building 10 includes an HVAC system 100. HVAC system 100 may include a plurality of HVAC devices (e.g., heaters, chillers, air handling units, pumps, fans, thermal energy storage, etc.) configured to provide heating, cooling, ventilation, or other services for building 10. For example, HVAC system 100 is shown to include a waterside system 120 and an airside system 130. Waterside system 120 may provide a heated or chilled fluid to an air handling unit of airside system 130. Airside system 130 may use the heated or chilled fluid to heat or cool an airflow provided to building 10. An exemplary waterside system and airside system which may be used in HVAC system 100 are described in greater detail with reference to FIGS. 3-4.

HVAC system 100 is shown to include a chiller 102, a boiler 104, and a rooftop air handling unit (AHU) 106. Waterside system 120 may use boiler 104 and chiller 102 to heat or cool a working fluid (e.g., water, glycol, etc.) and may circulate the working fluid to AHU 106. In various embodiments, the HVAC devices of waterside system 120 may be located in or around building 10 (as shown in FIG. 1) or at an offsite location such as a central plant (e.g., a chiller plant, a steam plant, a heat plant, etc.). The working fluid may be heated in boiler 104 or cooled in chiller 102, depending on whether heating or cooling is required in building 10. Boiler 104 may add heat to the circulated fluid, for example, by burning a combustible material (e.g., natural gas) or using an electric heating element. Chiller 102 may place the circulated fluid in a heat exchange relationship with another fluid (e.g., a refrigerant) in a heat exchanger (e.g., an evaporator) to absorb heat from the circulated fluid. The working fluid from chiller 102 and/or boiler 104 may be transported to AHU 106 via piping 108.

AHU 106 may place the working fluid in a heat exchange relationship with an airflow passing through AHU 106 (e.g., via one or more stages of cooling coils and/or heating coils). The airflow may be, for example, outside air, return air from within building 10, or a combination of both. AHU 106 may transfer heat between the airflow and the working fluid to provide heating or cooling for the airflow. For example, AHU 106 may include one or more fans or blowers configured to pass the airflow over or through a heat exchanger containing the working fluid. The working fluid may then return to chiller 102 or boiler 104 via piping 110.

Airside system 130 may deliver the airflow supplied by AHU 106 (i.e., the supply airflow) to building 10 via air supply ducts 112 and may provide return air from building 10 to AHU 106 via air return ducts 114. In some embodiments, airside system 130 includes multiple variable air volume (VAV) units 116. For example, airside system 130 is shown to include a separate VAV unit 116 on each floor or zone of building 10. VAV units 116 may include dampers or other flow control elements that can be operated to control an amount of the supply airflow provided to individual zones of building 10. In other embodiments, airside system 130 delivers the supply airflow into one or more zones of building 10 (e.g., via supply ducts 112) without using intermediate VAV units 116 or other flow control elements. AHU 106 may include various sensors (e.g., temperature sensors, pressure sensors, etc.) configured to measure attributes of the supply airflow. AHU 106 may receive input from sensors located within AHU 106 and/or within the building zone and may adjust the flow rate, temperature, or other attributes of the supply airflow through AHU 106 to achieve setpoint conditions for the building zone.

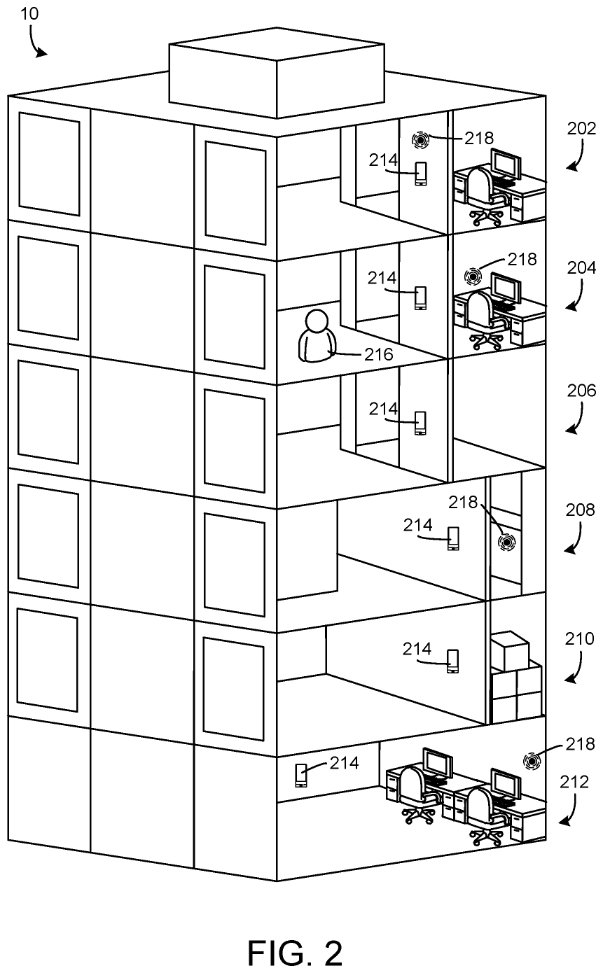

Referring now to FIG. 2, building 10 is shown in greater detail, according to an exemplary embodiment. Building 10 may have multiple zones or spaces. In FIG. 2, building 10 has zones 202, 204, 206, 208, 210, and 212. In building 10, the zones each correspond to a separate floor. In various embodiments, the zones of building 10 may be rooms, sections of a floor, apartment or condo units, retail space, etc. Each zone or space may have a corresponding control device 214. In some embodiments, control device 214 is at least one of a thermostat, a sensor, a controller, a display device, a concierge device, a medical monitor device, etc. Control device 214 may take input from users. The input may be an environmental setpoint, a concierge question, a payment, etc. In some embodiments, control device 214 can cause music and/or building announcements to be played in one or more of zones 202-212, cause the temperature and/or humidity to be regulated in one or more of zones 202-212, and/or any other control action.

In some embodiments, control device 214 can monitor the health of an occupant 216 of building 10. In some embodiments, control device 214 monitors heat signatures, heartrates, and any other information that can be collected from cameras, medical devices, and/or any other health related sensor. In some embodiments, building 10 has wireless transmitters 218 in each or some of zones 202-212. The wireless transmitters 218 may be routers, coordinators, and/or any other device broadcasting radio waves. In some embodiments, wireless transmitters 218 form a Wi-Fi network, a Zigbee network, a Bluetooth network, and/or any other kind of network.

In some embodiments, occupant 216 has a mobile device that can communicate with wireless transmitters 218. Control device 214 may use the signal strengths between the mobile device of occupant 216 and the wireless transmitters 218 to determine what zone the occupant is in. In some embodiments, control device 214 causes temperature setpoints, music and/or other control actions to follow occupant 216 as the occupant 216 moves from one zone to another zone (i.e., from one floor to another floor).

In some embodiments, control devices 214 are connected to a building management system, a weather server, and/or a building emergency sensor(s). In some embodiments, control devices 214 may receive emergency notifications from the building management system, the weather server, and/or the building emergency sensor(s). Based on the nature of the emergency, control devices 214 may give directions to an occupant of the building. In some embodiments, the direction may be to respond to an emergency (e.g., call the police, hide and turn the lights off, etc.). In various embodiments, the directions given to the occupant (e.g., occupant 216) may be navigation directions. For example, zone 212 may be a safe zone with no windows an individual (e.g., occupant 216). If control devices 214 determines that there are high winds around building 10, the control device 214 may direct occupants of zones 202-210 to zone 212 if zone 212 has no windows.

Referring now to FIG. 3, a block diagram of a waterside system 300 is shown, according to some embodiments. In various embodiments, waterside system 300 may supplement or replace waterside system 120 in HVAC system 100 or may be implemented separate from HVAC system 100. When implemented in HVAC system 100, waterside system 300 may include a subset of the HVAC devices in HVAC system 100 (e.g., boiler 104, chiller 102, pumps, valves, etc.) and may operate to supply a heated or chilled fluid to AHU 106. The HVAC devices of waterside system 300 may be located within building 10 (e.g., as components of waterside system 120) or at an offsite location such as a central plant.

In FIG. 3, waterside system 300 is shown as a central plant having a plurality of subplants 302-312. Subplants 302-312 are shown to include a heater subplant 302, a heat recovery chiller subplant 304, a chiller subplant 306, a cooling tower subplant 308, a hot thermal energy storage (TES) subplant 310, and a cold thermal energy storage (TES) subplant 312. Subplants 302-312 consume resources (e.g., water, natural gas, electricity, etc.) from utilities to serve the thermal energy loads (e.g., hot water, cold water, heating, cooling, etc.) of a building or campus. For example, heater subplant 302 may be configured to heat water in a hot water loop 314 that circulates the hot water between heater subplant 302 and building 10. Chiller subplant 306 may be configured to chill water in a cold water loop 316 that circulates the cold water between chiller subplant 306 building 10. Heat recovery chiller subplant 304 may be configured to transfer heat from cold water loop 316 to hot water loop 314 to provide additional heating for the hot water and additional cooling for the cold water. Condenser water loop 318 may absorb heat from the cold water in chiller subplant 306 and reject the absorbed heat in cooling tower subplant 308 or transfer the absorbed heat to hot water loop 314. Hot TES subplant 310 and cold TES subplant 312 may store hot and cold thermal energy, respectively, for subsequent use.

Hot water loop 314 and cold water loop 316 may deliver the heated and/or chilled water to air handlers located on the rooftop of building 10 (e.g., AHU 106) or to individual floors or zones of building 10 (e.g., VAV units 116). The air handlers push air past heat exchangers (e.g., heating coils or cooling coils) through which the water flows to provide heating or cooling for the air. The heated or cooled air may be delivered to individual zones of building 10 to serve the thermal energy loads of building 10. The water then returns to subplants 302-312 to receive further heating or cooling.

Although subplants 302-312 are shown and described as heating and cooling water for circulation to a building, it is understood that any other type of working fluid (e.g., glycol, CO2, etc.) may be used in place of or in addition to water to serve the thermal energy loads. In other embodiments, subplants 302-312 may provide heating and/or cooling directly to the building or campus without requiring an intermediate heat transfer fluid. These and other variations to waterside system 300 are within the teachings of the present disclosure.

Each of subplants 302-312 may include a variety of equipment configured to facilitate the functions of the subplant. For example, heater subplant 302 is shown to include a plurality of heating elements 320 (e.g., boilers, electric heaters, etc.) configured to add heat to the hot water in hot water loop 314. Heater subplant 302 is also shown to include several pumps 322 and 324 configured to circulate the hot water in hot water loop 314 and to control the flow rate of the hot water through individual heating elements 320. Chiller subplant 306 is shown to include a plurality of chillers 332 configured to remove heat from the cold water in cold water loop 316. Chiller subplant 306 is also shown to include several pumps 334 and 336 configured to circulate the cold water in cold water loop 316 and to control the flow rate of the cold water through individual chillers 332.

Heat recovery chiller subplant 304 is shown to include a plurality of heat recovery heat exchangers 326 (e.g., refrigeration circuits) configured to transfer heat from cold water loop 316 to hot water loop 314. Heat recovery chiller subplant 304 is also shown to include several pumps 328 and 330 configured to circulate the hot water and/or cold water through heat recovery heat exchangers 326 and to control the flow rate of the water through individual heat recovery heat exchangers 226. Cooling tower subplant 208 is shown to include a plurality of cooling towers 338 configured to remove heat from the condenser water in condenser water loop 318. Cooling tower subplant 308 is also shown to include several pumps 340 configured to circulate the condenser water in condenser water loop 318 and to control the flow rate of the condenser water through individual cooling towers 338.

Hot TES subplant 310 is shown to include a hot TES tank 342 configured to store the hot water for later use. Hot TES subplant 310 may also include one or more pumps or valves configured to control the flow rate of the hot water into or out of hot TES tank 342. Cold TES subplant 312 is shown to include cold TES tanks 344 configured to store the cold water for later use. Cold TES subplant 312 may also include one or more pumps or valves configured to control the flow rate of the cold water into or out of cold TES tanks 344.

In some embodiments, one or more of the pumps in waterside system 300 (e.g., pumps 322, 324, 328, 330, 334, 336, and/or 340) or pipelines in waterside system 300 include an isolation valve associated therewith. Isolation valves may be integrated with the pumps or positioned upstream or downstream of the pumps to control the fluid flows in waterside system 300. In various embodiments, waterside system 300 may include more, fewer, or different types of devices and/or subplants based on the particular configuration of waterside system 300 and the types of loads served by waterside system 300.

Referring now to FIG. 4, airside system 400 is shown to include an economizer-type air handling unit (AHU) 402. Economizer-type AHUs vary the amount of outside air and return air used by the air handling unit for heating or cooling. For example, AHU 402 may receive return air 404 from building zone 406 via return air duct 408 and may deliver supply air 410 to building zone 406 via supply air duct 412. In some embodiments, AHU 402 is a rooftop unit located on the roof of building 10 (e.g., AHU 4506 as shown in FIG. 1) or otherwise positioned to receive both return air 404 and outside air 414. AHU 402 may be configured to operate exhaust air damper 416, mixing damper 418, and outside air damper 420 to control an amount of outside air 414 and return air 404 that combine to form supply air 410. Any return air 404 that does not pass through mixing damper 418 may be exhausted from AHU 402 through exhaust damper 416 as exhaust air 422.

Each of dampers 416-420 may be operated by an actuator. For example, exhaust air damper 416 may be operated by actuator 424, mixing damper 418 may be operated by actuator 426, and outside air damper 420 may be operated by actuator 428. Actuators 424-428 may communicate with an AHU controller 430 via a communications link 432. Actuators 424-428 may receive control signals from AHU controller 430 and may provide feedback signals to AHU controller 430. Feedback signals may include, for example, an indication of a current actuator or damper position, an amount of torque or force exerted by the actuator, diagnostic information (e.g., results of diagnostic tests performed by actuators 424-428), status information, commissioning information, configuration settings, calibration data, and/or other types of information or data that may be collected, stored, or used by actuators 424-428. AHU controller 430 may be an economizer controller configured to use one or more control algorithms (e.g., state-based algorithms, extremum seeking control (ESC) algorithms, proportional-integral (PI) control algorithms, proportional-integral-derivative (PID) control algorithms, model predictive control (MPC) algorithms, feedback control algorithms, etc. to control actuators 424-428.

Still referring to FIG. 4, AHU 402 is shown to include a cooling coil 434, a heating coil 436, and a fan 438 positioned within supply air duct 412. Fan 438 may be configured to force supply air 410 through cooling coil 434 and/or heating coil 436 and provide supply air 410 to building zone 406. AHU controller 430 may communicate with fan 438 via communications link 440 to control a flow rate of supply air 410. In some embodiments, AHU controller 430 controls an amount of heating or cooling applied to supply air 410 by modulating a speed of fan 438.

Cooling coil 434 may receive a chilled fluid from waterside system 200 (e.g., from cold water loop 316) via piping 442 and may return the chilled fluid to waterside system 200 via piping 444. Valve 446 may be positioned along piping 442 or piping 444 to control a flow rate of the chilled fluid through cooling coil 474. In some embodiments, cooling coil 434 includes multiple stages of cooling coils that can be independently activated and deactivated (e.g., by AHU controller 430, by BMS controller 466, etc.) to modulate an amount of cooling applied to supply air 410.

Heating coil 436 may receive a heated fluid from waterside system 200 (e.g., from hot water loop 314) via piping 448 and may return the heated fluid to waterside system 200 via piping 450. Valve 452 may be positioned along piping 448 or piping 450 to control a flow rate of the heated fluid through heating coil 436. In some embodiments, heating coil 436 includes multiple stages of heating coils that can be independently activated and deactivated (e.g., by AHU controller 430, by BMS controller 466, etc.) to modulate an amount of heating applied to supply air 410.

Each of valves 446 and 452 may be controlled by an actuator. For example, valve 446 may be controlled by actuator 454 and valve 452 may be controlled by actuator 456. Actuators 454-456 may communicate with AHU controller 430 via communications links 458-460. Actuators 454-456 may receive control signals from AHU controller 430 and may provide feedback signals to controller 430. In some embodiments, AHU controller 430 receives a measurement of the supply air temperature from a temperature sensor 462 positioned in supply air duct 412 (e.g., downstream of cooling coil 434 and/or heating coil 436). AHU controller 430 may also receive a measurement of the temperature of building zone 406 from a temperature sensor 464 located in building zone 406.

In some embodiments, AHU controller 430 operates valves 446 and 452 via actuators 454-456 to modulate an amount of heating or cooling provided to supply air 410 (e.g., to achieve a set point temperature for supply air 410 or to maintain the temperature of supply air 410 within a set point temperature range). The positions of valves 446 and 452 affect the amount of heating or cooling provided to supply air 410 by cooling coil 434 or heating coil 436 and may correlate with the amount of energy consumed to achieve a desired supply air temperature. AHU 430 may control the temperature of supply air 410 and/or building zone 406 by activating or deactivating coils 434-436, adjusting a speed of fan 438, or a combination of both.

Still referring to FIG. 4, airside system 400 is shown to include a building management system (BMS) controller 466 and a control device 214. BMS controller 466 may include one or more computer systems (e.g., servers, supervisory controllers, subsystem controllers, etc.) that serve as system level controllers, application or data servers, head nodes, or master controllers for airside system 400, waterside system 200, HVAC system 100, and/or other controllable systems that serve building 10. BMS controller 466 may communicate with multiple downstream building systems or subsystems (e.g., HVAC system 100, a security system, a lighting system, waterside system 200, etc.) via a communications link 470 according to like or disparate protocols (e.g., LON, BACnet, etc.). In various embodiments, AHU controller 430 and BMS controller 466 may be separate (as shown in FIG. 4) or integrated. In an integrated implementation, AHU controller 430 may be a software module configured for execution by a processor of BMS controller 466.

In some embodiments, AHU controller 430 receives information from BMS controller 466 (e.g., commands, set points, operating boundaries, etc.) and provides information to BMS controller 466 (e.g., temperature measurements, valve or actuator positions, operating statuses, diagnostics, etc.). For example, AHU controller 430 may provide BMS controller 466 with temperature measurements from temperature sensors 462-464, equipment on/off states, equipment operating capacities, and/or any other information that can be used by BMS controller 466 to monitor or control a variable state or condition within building zone 406.

Control device 214 may include one or more user control devices. Control device 214 may include one or more human-machine interfaces or client interfaces (e.g., graphical user interfaces, reporting interfaces, text-based computer interfaces, client-facing web services, web servers that provide pages to web clients, etc.) for controlling, viewing, or otherwise interacting with HVAC system 100, its subsystems, and/or devices. Control device 214 may be a computer workstation, a client terminal, a remote or local interface, or any other type of user interface device. Control device 214 may be a stationary terminal or a mobile device. For example, control device 214 may be a desktop computer, a computer server with a user interface, a laptop computer, a tablet, a smartphone, a PDA, or any other type of mobile or non-mobile device. Control device 214 may communicate with BMS controller 466 and/or AHU controller 430 via communications link 472. Communications link 472 may be any kind of electronic communications link (e.g., a Wi-Fi network, a wired Ethernet network, a Zigbee network, a Bluetooth network, the Internet, a building WAN, etc.) and may use any of a variety of communications protocols (e.g., BACnet, IP, LON, etc.).

### Control Device

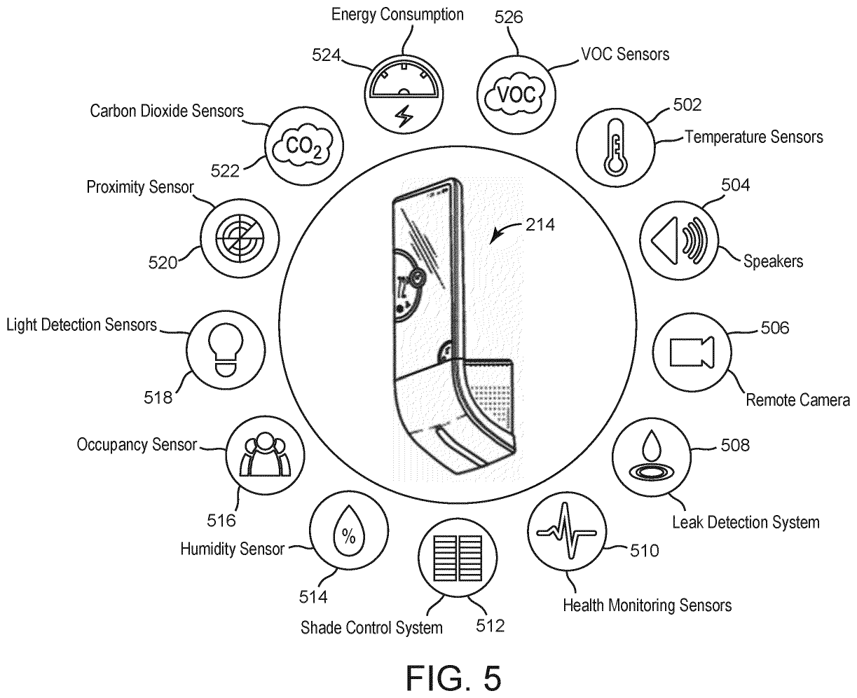

Referring now to FIG. 5, an example control device 214 is shown, according to some embodiments. Control device 214 may include a variety of sensors and may be configured to communicate with a variety of external systems or devices. For example, control device 214 may include temperature sensors 502, speakers 504, a remote camera 506, a leak detection system 508, health monitoring sensors 510, a shade control system 512, humidity sensors 514, occupancy sensors 516, light detection sensors 518, proximity sensors 520, carbon dioxide sensors 522, energy consumption sensors 524, volatile organic compound sensors (VOC) 526, or any of a variety of other sensors. Alternatively, control device 214 may receive input from external sensors configured to measure such variables. The external sensors may communicate with control device 214 via an IP-based network, a PAN, and/or the Internet, for example.

In some embodiments, speakers 504 are located locally as a component of control device 214. Speakers 504 may be low power speakers used for playing audio to the immediate occupant of control device 214 and/or occupants of the zone in which control device 214 is located. In some embodiments, speakers 504 may be remote speakers connected to control device 214 via an electronic network. In some embodiments, speakers 504 are a building audio system, an emergency alert system, and/or alarm system configured to broadcast building wide and/or zone messages or alarms.

Control device 214 may communicate with remote camera 506, shade control system 512, leak detection system 508, HVAC system 100, or any of a variety of other external systems or devices which may be used in a home automation system or a building automation system. Control device 214 may provide a variety of monitoring and control interfaces to allow a user to control all of the systems and devices connected to control device 214. Additional examples of features that can be associated with control device 214 are described in greater detail below.

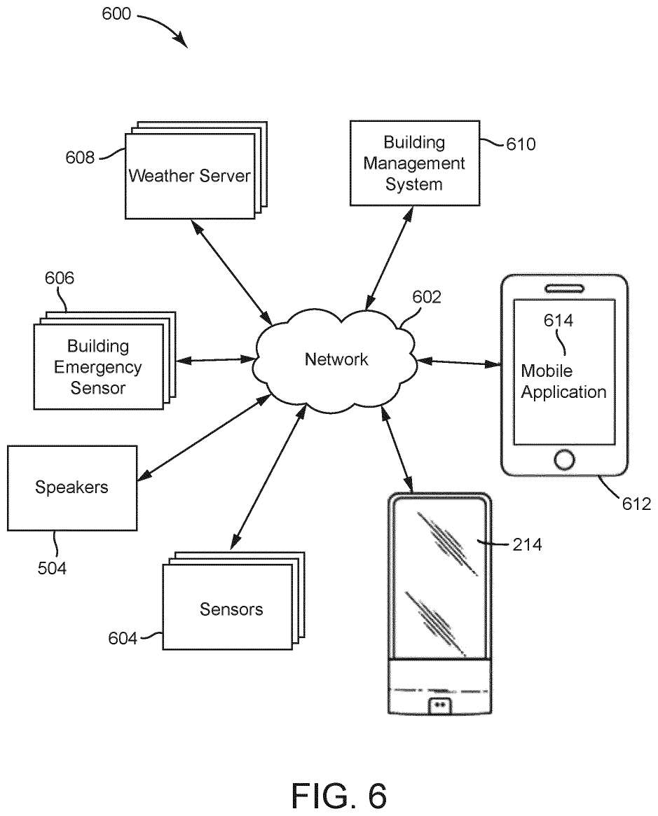

Referring now to FIG. 6, a block diagram of communications system 600 is shown, according to some embodiments. System 600 can be implemented in a building (e.g. building 10) and is shown to include control device 214, an electronic network 602, air quality sensors 604, building emergency sensor(s) 606, weather server(s) 608, a building management system 610, and a user device 612 with a mobile application 614 (e.g., smart phone with associated mobile application). System 600 connects devices, systems, and servers via network 602 so that building information, HVAC controls, emergency information, navigation directions, and other information can be passed between devices. In some embodiments, control device 214 is connected to speakers 504 as described with reference to FIG. 5.

In some embodiments, network 602 communicatively couples the devices, systems, and servers of system 600. In some embodiments, network 602 is at least one of and/or a combination of a Wi-Fi network, a wired Ethernet network, a Zigbee network, and a Bluetooth network. Network 602 may be a local area network or a wide area network (e.g., the Internet, a building WAN, etc.) and may use a variety of communications protocols (e.g., BACnet, IP, LON, etc.) Network 602 may include routers, modems, and/or network switches.

In some embodiments, control device 214 is configured to receive emergency information, navigation directions, occupant information, concierge information, air quality information, and other types of information via network 602. In some embodiments, the information is received from building management system 610 via network 602. In various embodiments, the information is received from the Internet via network 602. In some embodiments, control device 214 is at least one of, or a combination of, a thermostat, a humidistat, a light controller, and any other wall-mounted and/or handheld device.

In some embodiments, control device 214 may be communicatively coupled to weather server(s) 608 via network 602. In some embodiments, the control device 214 may be configured to receive weather alerts (e.g., high and low daily temperature, five day forecast, thirty day forecast, etc.) from weather server(s) 608. Control device 214 may be configured to receive emergency weather alerts (e.g., flood warnings, fire warnings, thunder storm warnings, winter storm warnings, etc.) In some embodiments, control device 214 may be configured to display emergency warnings via a user interface of control device 214 when control device 214 receives an emergency weather alert from weather server(s) 608. The control device 214 may be configured to display emergency warnings based on the data received from building emergency sensor(s) 606. In some embodiments, the control device 214 may cause a siren (e.g., speakers 504 and/or building emergency sensor(s) 606) to alert occupants of the building of an emergency, cause all doors to become locked and/or unlocked, cause an advisory message be broadcast through the building, and control any other actuator or system necessary for responding to a building emergency. In further embodiments, the weather server(s) 608 may be configured to provide air quality information to the control device 214. For example, the weather server(s) 608 may provide air quality information such as pollen levels, mold levels, particulate levels, etc.

In some embodiments, control device 214 is configured to communicate with building management system 610 via network 602. Control device 214 may be configured to transmit environmental setpoints (e.g., temperature setpoint, humidity setpoint, etc.) to building management system 610. In some embodiments, building management system 610 may be configured to cause zones of a building (e.g., building 10) to be controlled to the setpoint received from control device 214. In further embodiments, the building management system 610 may be configured to control one or more fans or ventilators to provide air flow into and out of a building (e.g. building 10). In some embodiments, building management system 610 may be configured to control the lighting of a building. In some embodiments, building management system 610 may be configured to transmit emergency information to control device 214. In some embodiments, the emergency information is a notification of an active shooter lockdown, a tornado warning, a flood warning, a thunderstorm warning, and/or any other warning. In some embodiments, building management system 610 is connected to various weather servers or other web servers from which building management system 610 receives emergency warning information. In various embodiments, building management system is a computing system of a hotel. Building management system 610 may keep track of hotel occupancy, may relay requests to hotel staff, and/or perform any other functions of a hotel computing system.

Control device 214 is configured to communicate with user device 612 via network 602. In some embodiments, user device 612 is a smartphone, a tablet, a laptop computer, and/or any other mobile and/or stationary computing device. In some embodiments, user device 612 communicates calendar information to control device 214. In some embodiments, the calendar information is stored and/or entered by a user into calendar application 614. In some embodiments, calendar application 414 is at least one of Outlook, Google Calendar, Fantastical, Shifts, CloudCal, DigiCal, and/or any other calendar application. In some embodiments, control device 214 receives calendar information from the calendar application such as times and locations of appointments, times and locations of meetings, and/or any other information. Control device 214 may be configured to display building map direction to a user associated with user device 612 and/or any other information. User device 612 may be restricted from directly accessing a control network associated with building management system 610 (e.g., a BACnet network). Instead, user device 612 may indirectly access such a control network through a user interface provided by building management system 610 and/or associated applications.

In some embodiments, a user may press a button on a user interface of control device 214 indicating a building emergency. The user may be able to indicate the type of emergency (e.g., fire, flood, active shooter, etc.) Control device 214 may communicate an alert to building management system 610, user device 612, and any other device, system, and/or server.

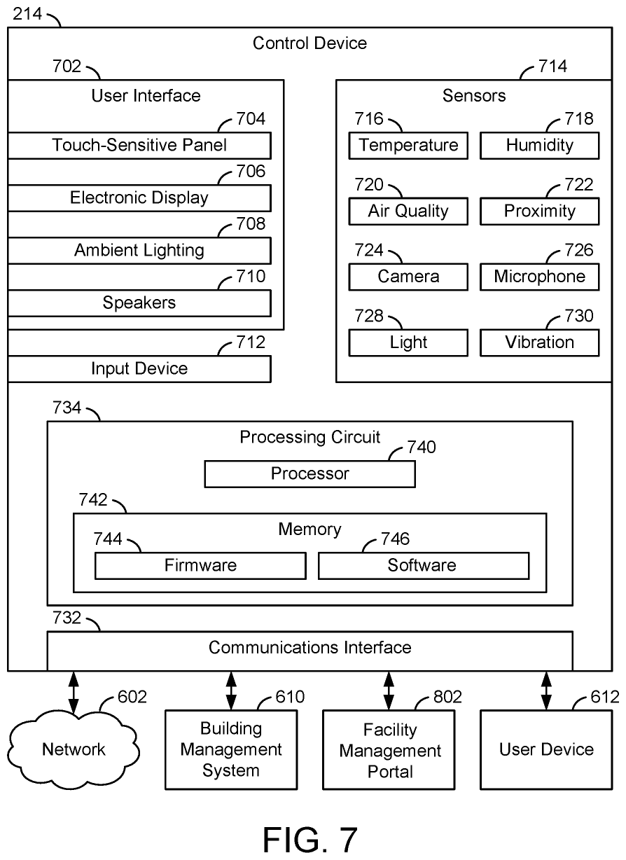

Referring now to FIG. 7, a block diagram illustrating control device 214 in greater detail is shown, according to some embodiments. Control device 214 is shown to include a variety of user interface devices or components 702. User interface devices 702 may be configured to receive input from a user and provide output to a user in various forms. For example, user interface devices 702 are shown to include a touch-sensitive panel 704, an electronic display 706, ambient lighting 708, speakers 710 (e.g., speakers 504), and an input device 712. Input device 712 may include a microphone configured to receive voice commands from a user, a keyboard, buttons, switches, dials, and/or any other user-operable input device. It is contemplated that user interface devices 702 may include any type of device configured to receive input from a user and/or provide an output to a user in any of a variety of forms (e.g., touch, text, video, graphics, audio, vibration, etc.).

Touch-sensitive panel 704 may be a touchscreen or other type of electronic display configured to present information to a user in a visual format (e.g., daily schedule, text, graphics, etc.) and receive input from a user (e.g., via a touch-sensitive panel). For example, touch sensitive panel 704 may include a touch-sensitive panel layered on top of an electronic visual display. A user can provide inputs through simple or multi-touch gestures by touching panel 704 with one or more fingers and/or with a stylus or pen. Touch-sensitive panel 704 can use any of a variety of touch-sensing technologies to receive user inputs, such as capacitive sensing (e.g., surface capacitance, projected capacitance, mutual capacitance, self-capacitance, etc.), resistive sensing, surface acoustic wave, infrared grid, infrared acrylic projection, optical imaging, dispersive signal technology, acoustic pulse recognition, or other touch-sensitive technologies known in the art. Many of these technologies allow for multi-touch responsiveness of display 706 allowing registration of touch in two or even more locations at once. Display 706 may use any of a variety of display technologies such as light emitting diode (LED), organic light-emitting diode (OLED), liquid-crystal display (LCD), organic light-emitting transistor (OLET), surface-conduction electron-emitter display (SED), field emission display (FED), digital light processing (DLP), liquid crystal on silicon (LCoC), or any other display technologies known in the art. In some embodiments, the display 706 is configured to present visual media (e.g., text, graphics, etc.) without requiring a backlight.

The control device 214 may also include, or be in communication with, a number of sensors 714. The sensors 714 may be configured to measure a variable state or condition of the environment in which control device 214 is installed. For example, sensors 714 are shown to include a temperature sensor 716, a humidity sensor 718, an air quality sensor 720, a proximity sensor 722, a camera 724, a microphone 726, a light sensor 728, and a vibration sensor 730. Air quality sensor 720 may be configured to measure any of a variety of air quality variables such as oxygen level, carbon dioxide level, carbon monoxide level, allergens, pollutants, smoke, VOCs, etc. Proximity sensor 722 may include one or more sensors configured to detect the presence of people or devices proximate to control device 214. For example, proximity sensor 722 may include a near-field communications (NFC) sensor, a radio frequency identification (RFID) sensor, a Bluetooth sensor, a capacitive proximity sensor, a biometric sensor, or any other sensor configured to detect the presence of a person or device. Camera 724 may include a visible light camera, a motion detector camera, an infrared camera, an ultraviolet camera, an optical sensor, or any other type of camera. Light sensor 728 may be configured to measure ambient light levels. Vibration sensor 730 may be configured to measure vibrations from earthquakes or other seismic activity at the location of control device 214.

Still referring to FIG. 7, control device 214 is shown to include a communications interface 732 and a processing circuit 734. Communications interface 732 may include wired or wireless interfaces (e.g., jacks, antennas, transmitters, receivers, transceivers, wire terminals, etc.) for conducting data communications with various systems, devices, or networks. For example, communications interface 732 may include an Ethernet card and port for sending and receiving data via an Ethernet-based communications network and/or a Wi-Fi transceiver for communicating via a wireless communications network. Communications interface 732 may be configured to communicate via local area networks or wide area networks (e.g., the Internet, a building WAN, etc.) and may use a variety of communications protocols (e.g., BACnet, IP, LON, etc.).

Communications interface 732 may include a network interface configured to facilitate electronic data communications between control device 214 and various external systems or devices (e.g., network 602, building management system 610, a facility management portal 800, user device 612, etc.) For example, control device 214 may receive information from building management system 610 indicating one or more measured states of the controlled building (e.g., temperature, humidity, electric loads, etc.) and one or more states of HVAC equipment (e.g., equipment status, power consumption, equipment availability, etc.). In some embodiments, HVAC equipment may be lighting systems, building systems, actuators, chillers, heaters, and/or any other building equipment and/or system. Communications interface 732 may receive inputs from building management system 610 or HVAC equipment and may provide operating parameters (e.g., on/off decisions, set points, etc.) to building management system 610 or HVAC equipment. The operating parameters may cause building management system 610 to activate, deactivate, or adjust a set point for various types of home equipment or building equipment in communication with control device 214.

Processing circuit 734 is shown to include a processor 740 and memory 742. Processor 740 may be a general purpose or specific purpose processor, an application specific integrated circuit (ASIC), one or more field programmable gate arrays (FPGAs), a group of processing components, or other suitable processing components. Processor 740 may be configured to execute computer code or instructions stored in memory 742 or received from other computer readable media (e.g., CDROM, network storage, a remote server, etc.).

Memory 742 may include one or more devices (e.g., memory units, memory devices, storage devices, etc.) for storing data and/or computer code for completing and/or facilitating the various processes described in the present disclosure. Memory 742 may include random access memory (RAM), read-only memory (ROM), hard drive storage, temporary storage, non-volatile memory, flash memory, optical memory, or any other suitable memory for storing software objects and/or computer instructions. Memory 742 may include database components, object code components, script components, or any other type of information structure for supporting the various activities and information structures described in the present disclosure. Memory 742 may be communicably connected to processor 740 via processing circuit 734 and may include computer code for executing (e.g., by processor 740) one or more processes described herein. For example, memory 742 is shown to include firmware 744 and software 746. Various software modules such as voice command and control modules, building modules, payment modules, hotel modules, healthcare modules, occupancy modules, emergency modules and the like may be included in memory 742.

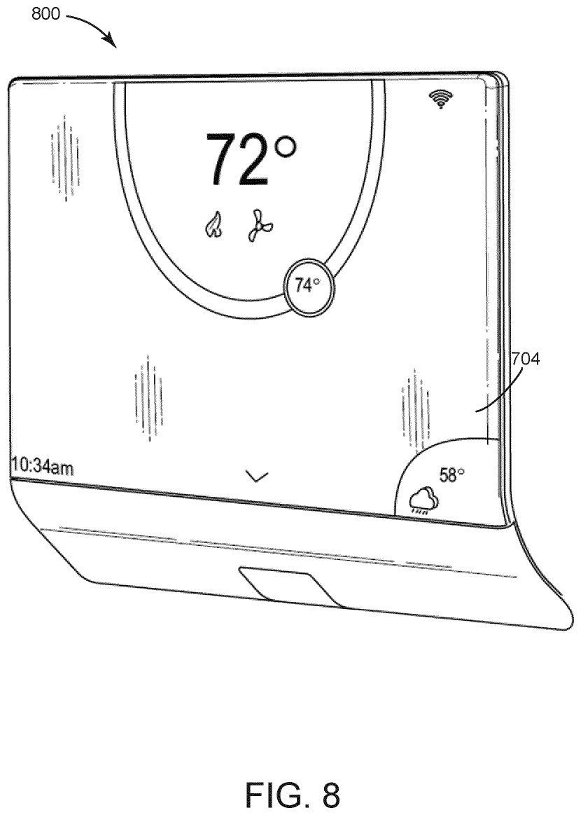

Referring now to FIG. 8, one embodiment of a multi-function control device 214 is shown. FIG. 8 shows a smart thermostat device 800. In some embodiments, thermostat device 800 is a GLAS Thermostat as produced and sold by Johnson Controls. Thermostat device 800 can be configured to perform some or all of the functions described above with respect to control device 214. As mentioned, thermostat device 800 can create, receive, and utilize a variety of data associated with a building facility (e.g., building 10) in order to optimize energy efficiency and create a user-friendly environment for building occupants. For example, an apartment building may include a thermostat device 800 in each apartment unit. Tenants of the apartment building can interact with device 800 to adjust heating or cooling settings, view weather information, configure an occupancy schedule, adjust lighting controls, view energy consumption information, view air quality information, initiate an emergency response protocol, initiate a maintenance request, etc. Thermostat device 800 may include a virtual assistant that allows users to interact with device 800 through voice commands. Thermostat device and/or building management system 610 can be configured to send notifications to user device 612 (e.g., a tenant's smartphone), for example, via mobile application 614. Data associated with thermostat device 800, building management system 610, and portal 802 can be stored locally (e.g., servers installed on-site at building 10 and/or on devices themselves), in cloud storage (e.g., remote servers), or a combination thereof.

Thermostat device 800 can be used in any type of building such as a retail building (e.g., coffee shops, clothing stores, etc.), a combined retail and residential building, etc. It may be difficult for building stakeholders (e.g., building managers, landlords, real estate investors, maintenance personnel, etc.) to efficiently and effectively monitor, commission, and service buildings and building control equipment. For example, a landlord may wish to obtain information regarding air quality and energy consumption within all of the properties owned or managed by the landlord. The landlord may be required to contact a variety of people, visit a variety of sites, or use a variety of systems in order to obtain all of the desired information. Moreover, the landlord may not be able to adjust control parameters or notify tenants of updates remotely. Facility management portal 802 provides an effective solution to this problem. The functions described as being performed by thermostat device 800 can also be performed by a variety of other user control devices 214.

### Facility Management Portal

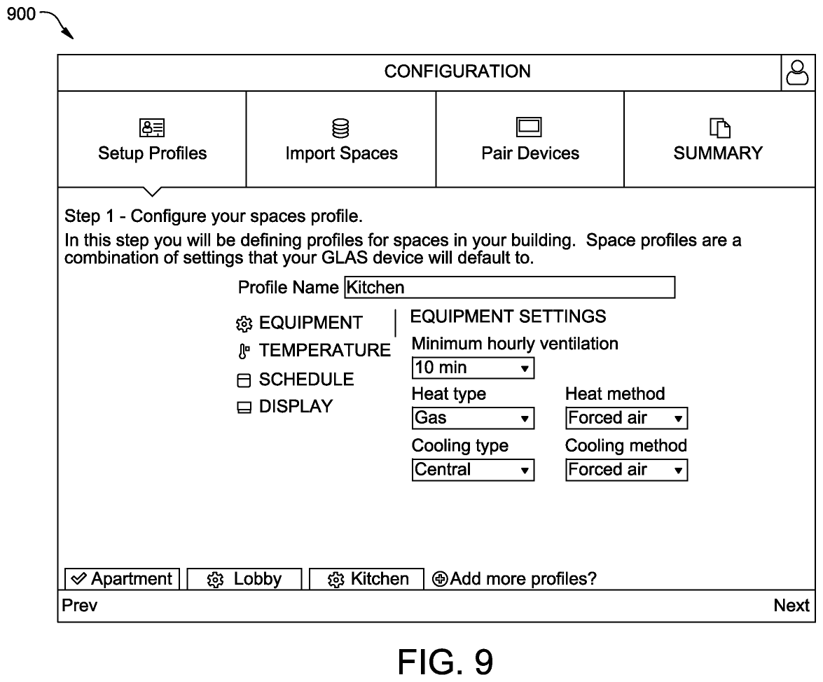

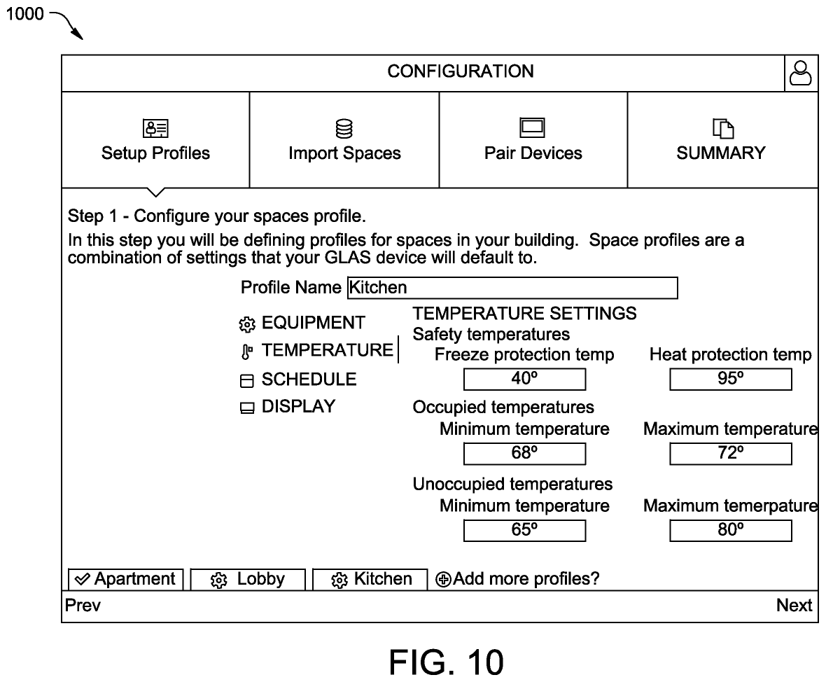

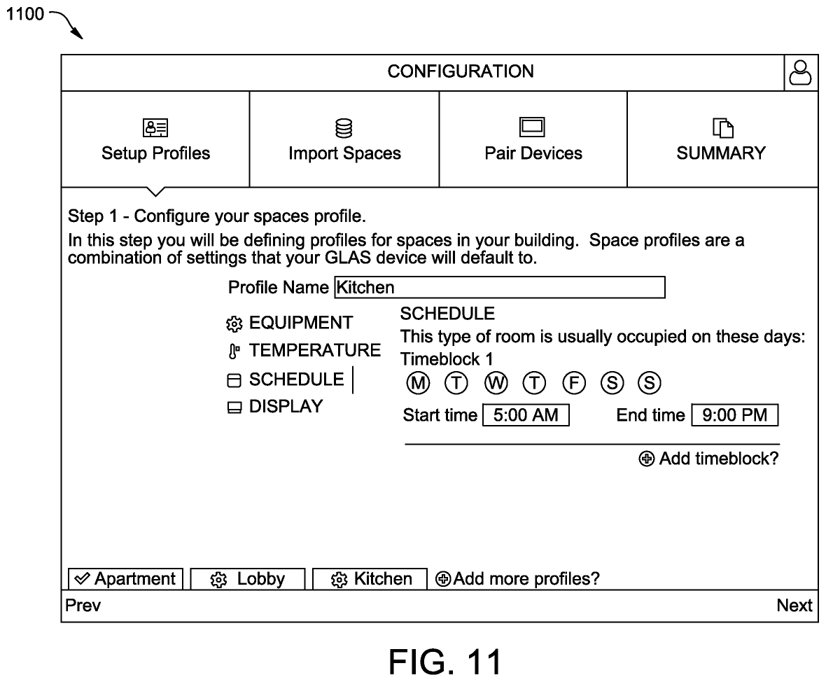

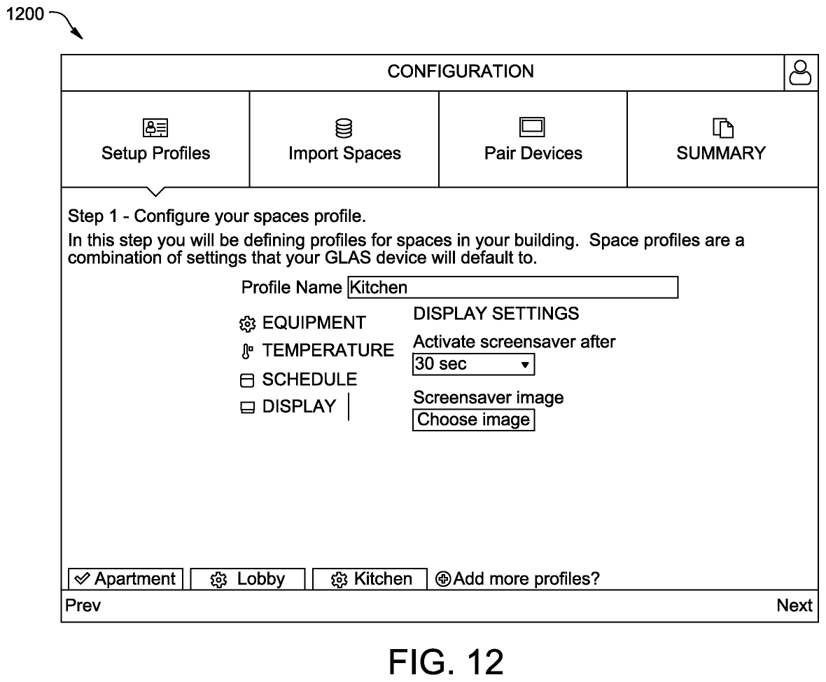

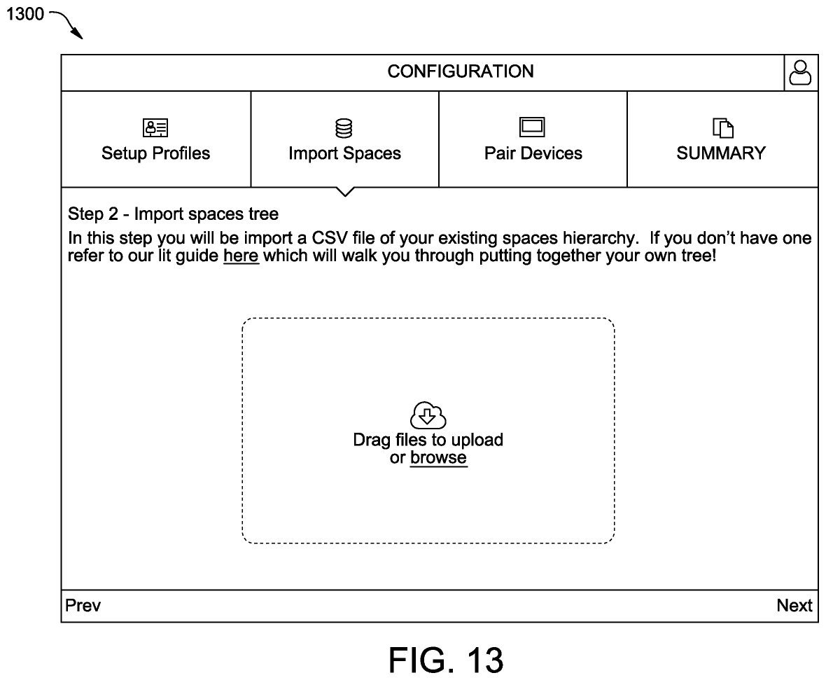

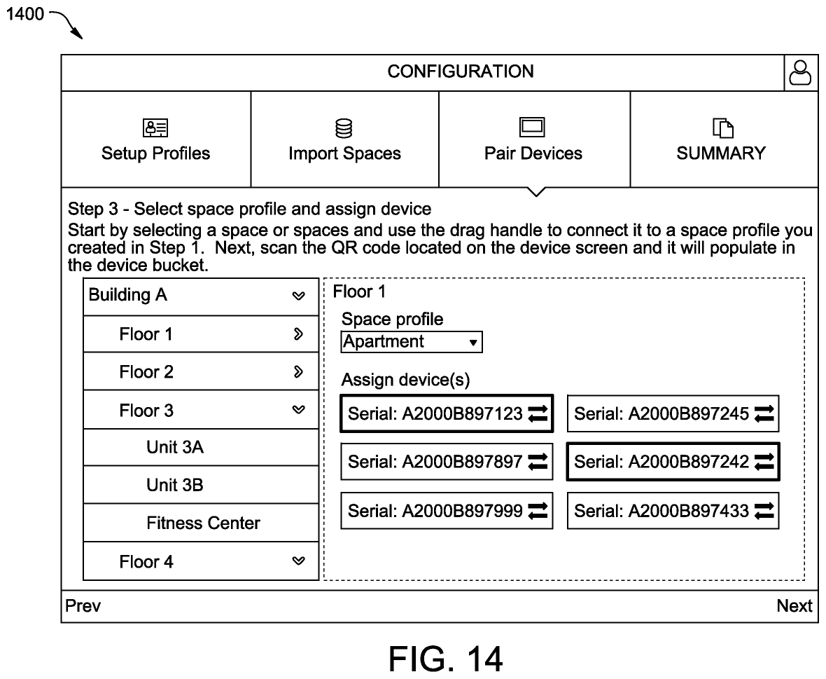

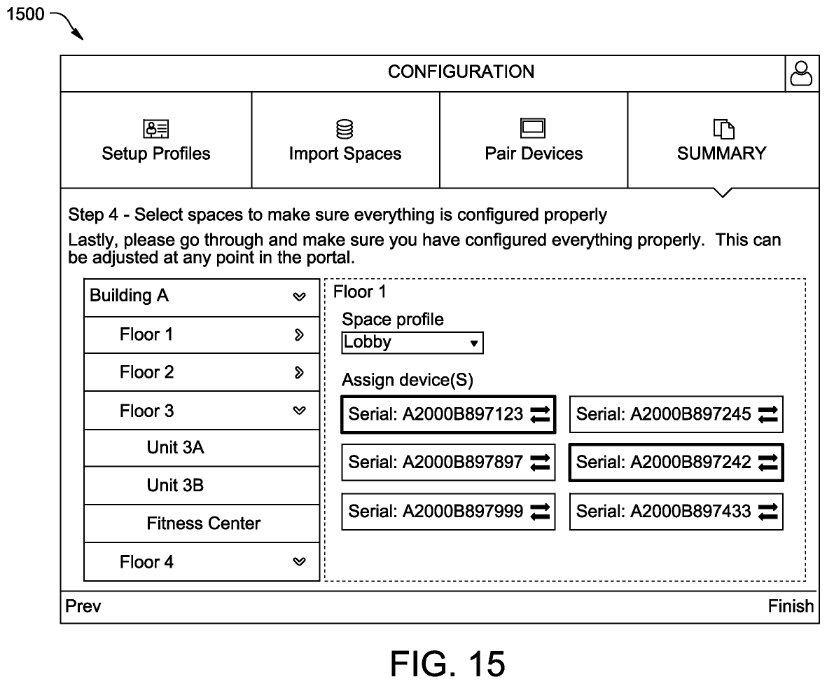

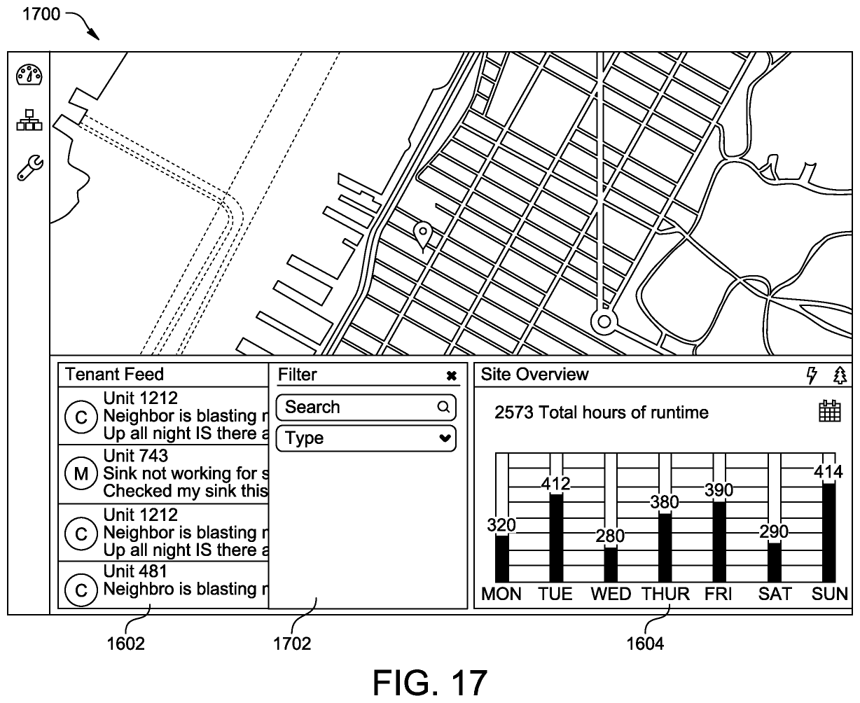

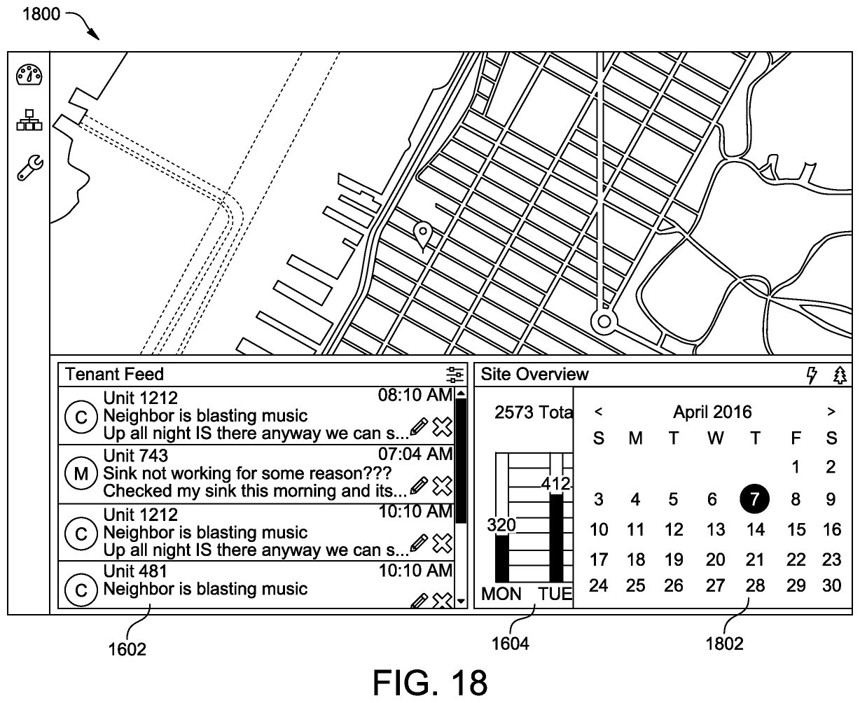

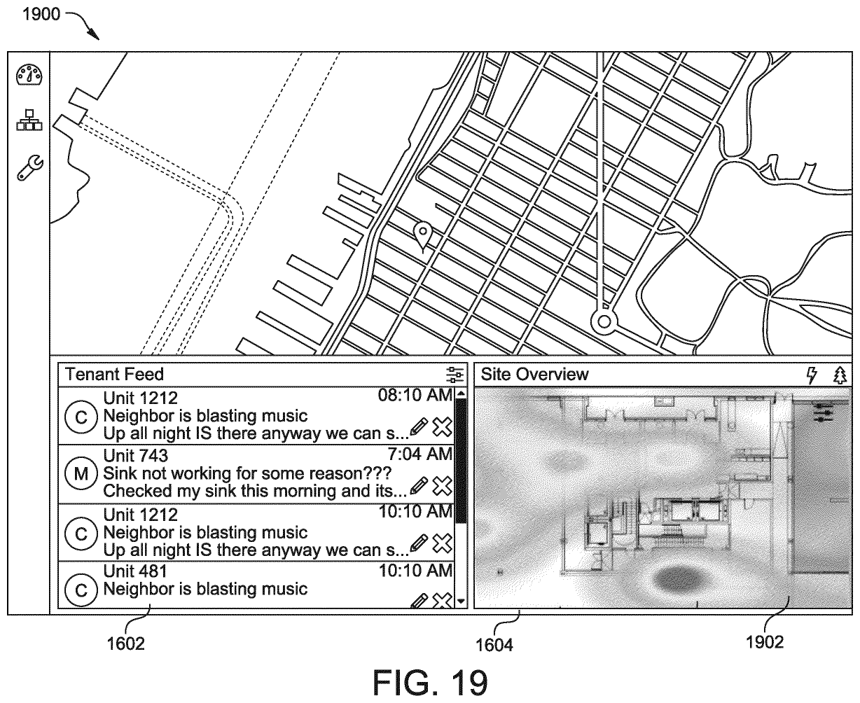

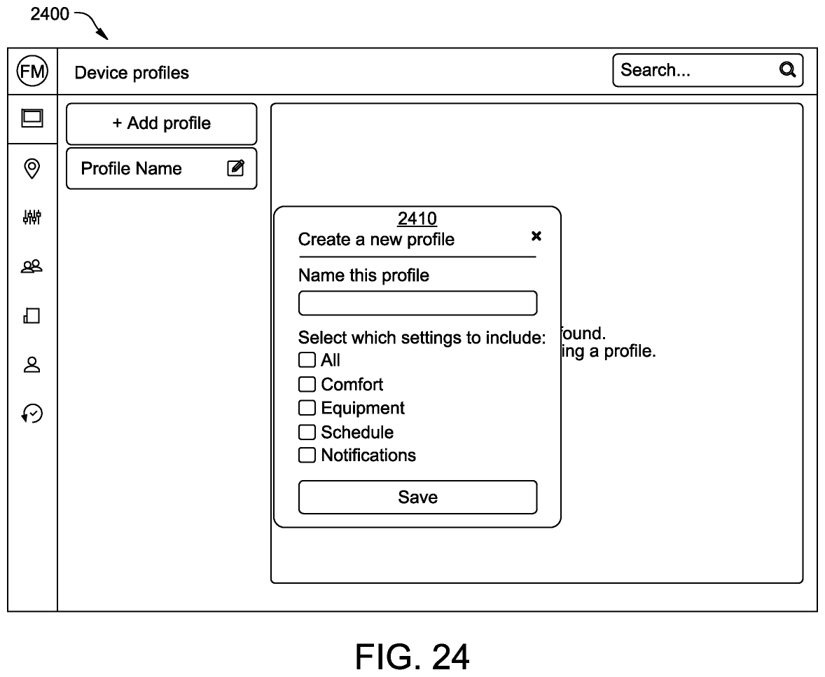

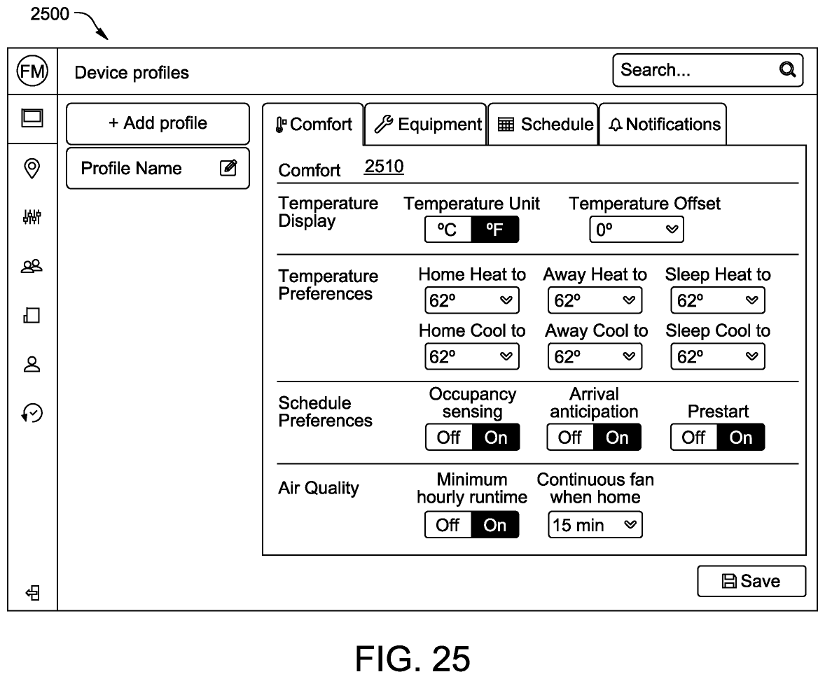

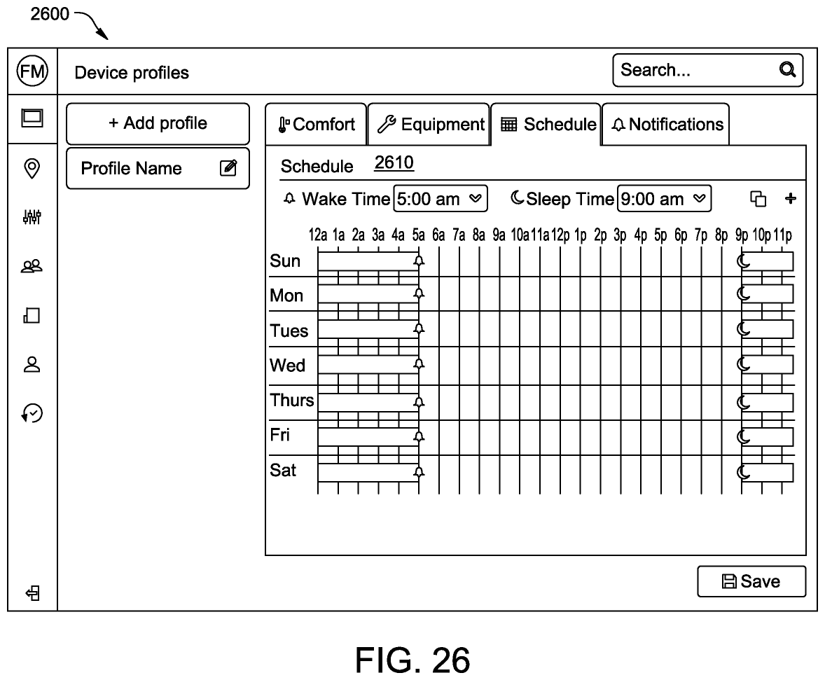

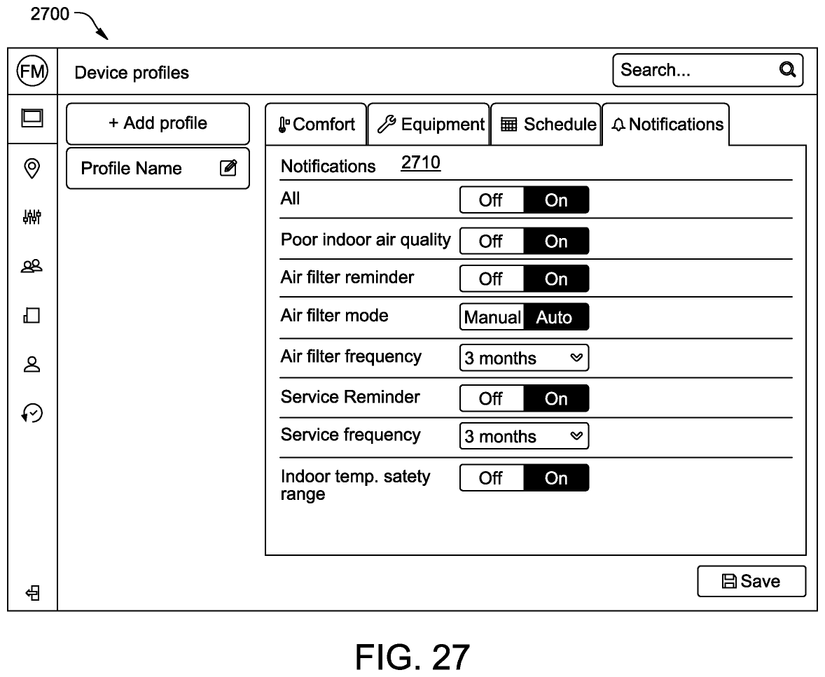

Referring now to FIGS. 9-34, various examples of user interfaces associated with facility management portal 802 are shown, according to various embodiments. Facility management portal 802 facilitates the creation of a user-friendly building ecosystem by providing users with a user interface that can perform a variety of different functions in response to inputs received from users. For example, building stakeholders can access portal 802 and a variety of data associated with various buildings through any type of user device (e.g., smartphone, laptop, personal computer, tablet, workstation, etc.) via an Internet connection or other type of connection. For example, when a new building is constructed, a general contractor and architect can design the building with strategic placement of thermostat devices 800 and associated sensors. Moreover, portal 802 can be used to provide said thermostat devices 800 with a baseline configuration. Once the building is finished, building stakeholders can monitor a variety of data associated with the building and perform servicing activities related to HVAC equipment, lighting, security systems, etc. via portal 802. Portal 802 can drive increased health and safety measures by improving efficiency related to emergency requests (e.g., fire, active shooter) and health-related issues (e.g., poor air quality). Facility management portal 802 may allow users to perform commissioning, remote controlling, and monitoring of thermostat devices 800 without having to interface with a building management system such as building management system 600 described above. Accordingly, users can manage thermostat devices 800 through portal 802 without installing an expensive building management system. As such, facility management portal 802 may also be referred to as a “thermostat manager” or another similar name. It will be appreciated that portal 802 and associated interfaces can be used with a variety of devices including thermostat device 800 and more generally a device such as control device 214. It will also be appreciated that certain interfaces shown in FIGS. 9-34 perform similar functions, and different approaches to creating an interface that performs such functions are both shown and contemplated.

Referring specifically to FIGS. 9-15, various examples of a configuration interface associated with portal 802 are shown, according to some embodiments. Interfaces 900, 1000, 1100, and 1200 can be used to configure space profiles. The spaces profiles include a combination of settings that thermostat device 800 will default to (e.g., when building is constructed, when tenant moves out, etc.). Users can create a variety of space profiles for use with different types of building spaces (e.g., apartment, library, grocery store, gym, etc.). Interface 900 can be used to configure HVAC equipment settings. For example, users can specify a minimum hourly ventilation (e.g., 10 minutes), a type of heating (e.g., gas), a method of heating (e.g., forced air), a cooling type (e.g., central), and a cooling method (e.g., forced air). Interface 1000 can be used to configure temperature settings. For example, user can specify safety temperatures (e.g., freeze protection temperature, heat protection temperature), occupied temperatures (e.g., minimum temperature, maximum temperature), and unoccupied temperatures (e.g., minimum temperature, maximum temperature). Interface 1100 can be used to configure occupancy schedules. For example, users can specify various time blocks where the building space is expected to be occupied or unoccupied. Interface 1200 can be used to configure display settings. For example, user can select an image (e.g., logo) to be displayed as a screensaver on thermostat device 800.

Interface 1300 can be used to import a spaces tree. The spaces tree, for example, may define relationships between building spaces such as floors, rooms, apartment units, restrooms, etc. User can upload a spaces tree (e.g., .csv file, .xls file, .bim file, .cad file) to portal 802 via interface 1300. In some embodiments, the spaces tree is created by a general contractor or architect associated with the building. Interface 1400 can be used to associate devices (e.g., thermostat devices 800) with building spaces as defined by the spaces tree. Devices can be associated with spaces via interface 1400 by scanning a QR code on the device, connecting to the device via Bluetooth or NFC, or entering a serial number or other identifier associated with the device, for example. Each building space associated with the spaces tree may have an associated space profile as defined by users via interfaces 900, 1000, 1100, and 1200, for example. Interface 1500 allows users to review information related to building spaces and devices before finalizing the configuration.

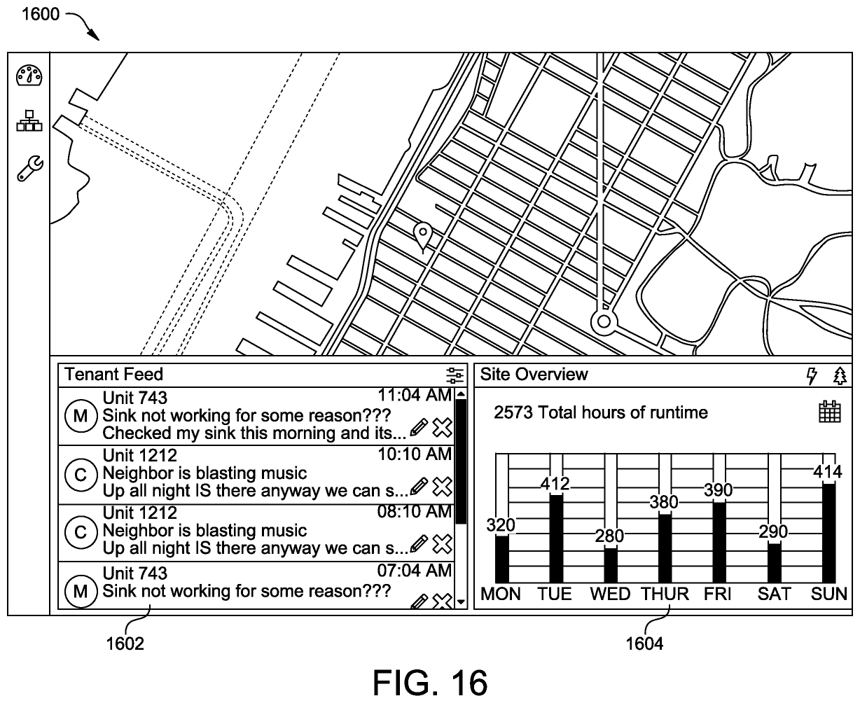

Referring now to FIGS. 16-19, various examples of a dashboard interface associated with portal 802 are shown, according to some embodiments. The dashboard interface can be unique to a specific building. As shown in interface 1600, the dashboard interface includes a map with a pin showing the location of the selected building. Consider, for example, a property owner with several different properties. The property owner can quickly and easily view a variety of data associated with each property through the dashboard interface of portal 802. As shown in interface 1600, in addition to the map, a tenant feed interface 1602 and a site overview interface 1604 can be included in the dashboard interface. Tenant feed 1602 can include a variety of issues (e.g., sink not working) associated with tenants of the building. Tenants can submit notifications or requests by interacting with thermostat device 800 and/or mobile application 614, for example. Users of portal 802 can delete notification in tenant feed 1602, provide comments in relation to notifications in tenant feed 1602 that can be relayed to the tenants, schedule maintenance appointments, etc. Moreover, site overview 1604 can provide a variety of information to users of portal 802 in a user-friendly format. As shown in interface 1600, site overview 1604 includes a cumulative total runtime of building equipment for each day of the past week. Building stakeholders can use this information to diagnose possible problems and inefficiencies associated with the building. This can lead to reduced energy costs and improved equipment performance, for example. Overview 1604 can also provide an indication of energy usage during time periods of peak demand (e.g., higher utility costs) compared to energy usage during time periods of standard demand.

Interface 1700 shows an example of search and filtering functionality associated with tenant feed 1602. For example, through dialog box 1702, users of portal 802 can search for notifications related to a specific apartment unit, a specific type of notification (e.g., neighbor blasting music), etc. Interface 1800 shows an example of calendar functionality associated with site overview 1604. For example, through interactive calendar 1802, users can view energy consumption data and other building information over any desired time period. Interface 1900 shows an example of air quality mapping functionality associated with the dashboard interface of portal 802. Users can quickly and easily view a map 1902 that provides an indication (e.g., via colors) of air quality readings (e.g., from devices 800 and associated sensors) across all spaces associated with the building. Air quality map 1902 provides an efficient and effective way for building stakeholders and other personnel to diagnose potential problems with air quality in a building.

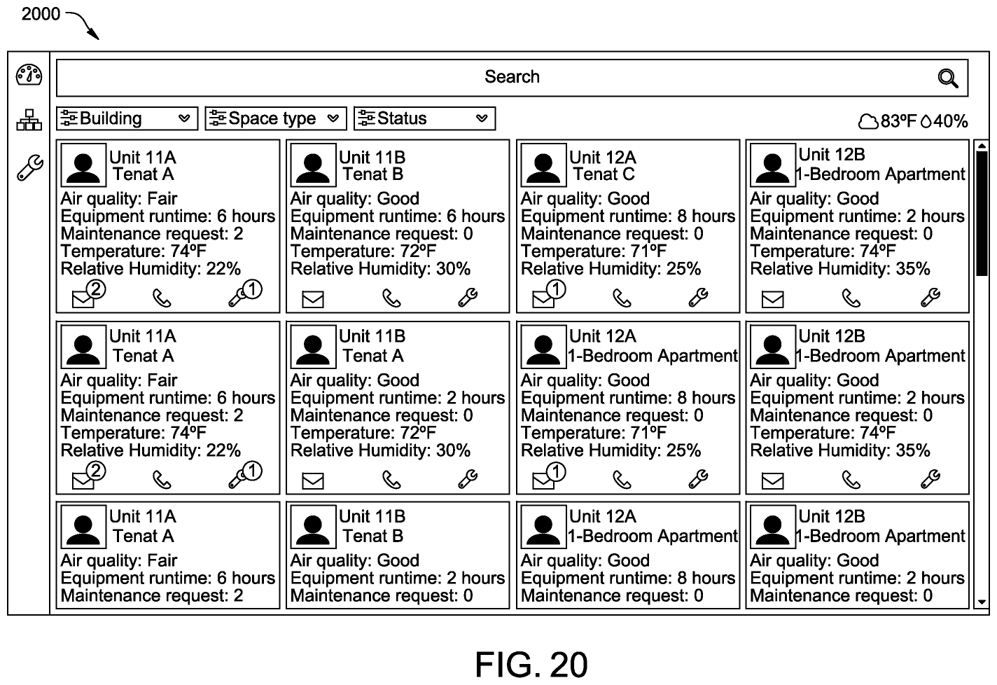

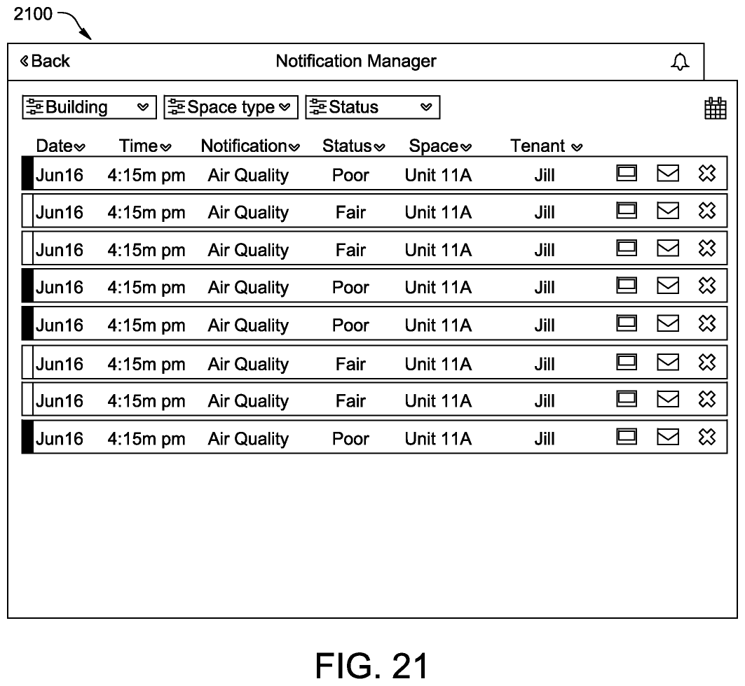

Referring now to FIGS. 20 and 21, two example notification management interfaces are shown, according to some embodiments. Interface 2000 shows an example tenant summary interface and includes data from a variety of building spaces and tenants. The data shown in the tenant summary interface includes air quality data (e.g., good, poor, bad), daily equipment runtime data (e.g., 6 hours of runtime for HVAC equipment), relative humidity data (e.g., 25%), temperature data (e.g., 72 degrees Fahrenheit), and other data such as maintenance requests. The data shown in interface 2000 may be updated periodically (e.g., daily) to provide an indication of the status of various building spaces. Interface 2000 may also provide a simple way for users of portal 802 to contact tenants, such as through email or a phone call. Interface 2100 is an example notification management interface, wherein notification associated with tenants can be easily viewed and managed. Interface 2100 may provide a colored indication of the status of each notification (e.g., emergency, not emergency, etc.). From interfaces 2000 and 2100, users of portal 802 can easily view related email messages, initiate phones calls, schedule maintenance events, and adjust settings (e.g., of device 800) related to the building spaces. Users can filter the notifications presented via interfaces 2000 and 2100 by searching, specifying a certain building, selecting a certain space, or selecting a certain status (e.g., poor air quality), for example.

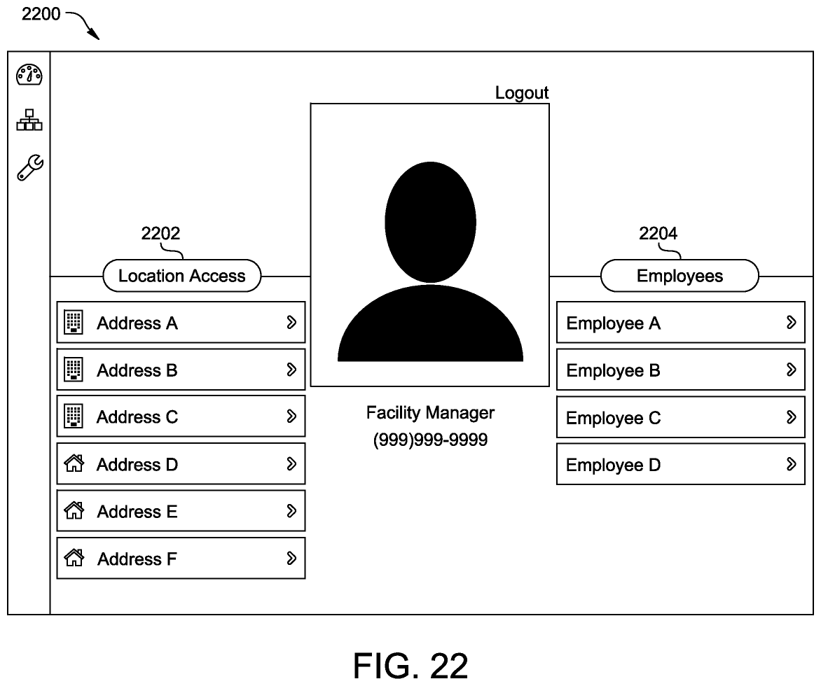

Referring now to FIG. 22, an example account management interface 2200 is shown, according to various embodiments. Building stakeholders and users of portal 802 may wish to limit the personnel with access to portal 802. For example, a customer using portal 802 may be a facility manager with full administrative rights to use all features of portal 802. The facility manger may then allow certain access to various employees 2204 (e.g., maintenance personnel, other stakeholders, etc.). The access granted to these employees may be limited to certain buildings 2202, for example. The ability to customize access to portal 802 in this manner ensures that all actions performed via portal 802 are intended.

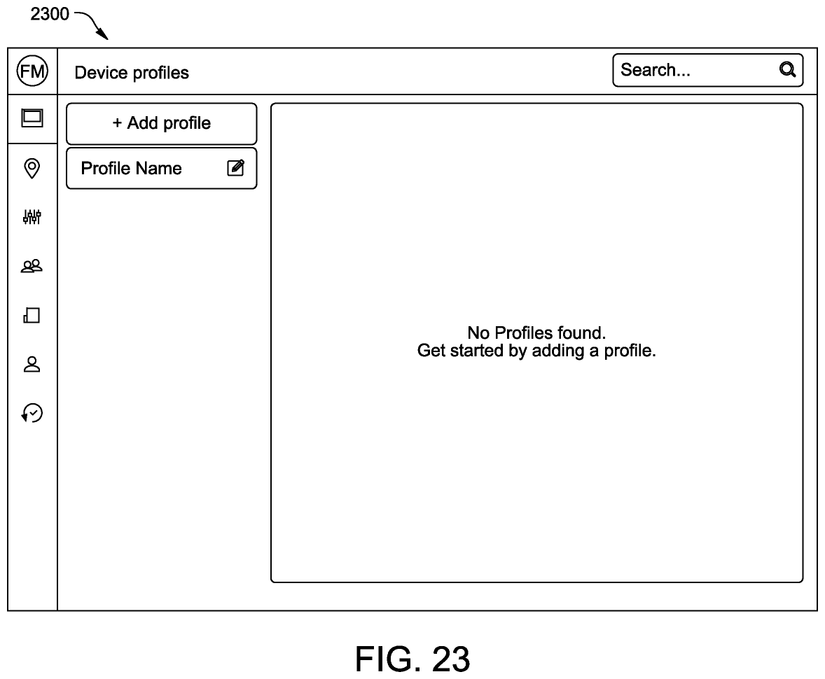

Referring now to FIGS. 23-27, example device profile interfaces associated with facility management portal 802 are shown, according to some embodiments. The device profile interfaces generally show settings associated with thermostat device 800 and allow users to configure a device profile that can be provided to one or more thermostat devices in a building. The device profiles may be the same as or similar to the spaces profiles as described above. For example, a facility manager may wish to provide a bassline configuration for all thermostat devices in a unit of a residential building such as an apartment unit or a condo unit. However, the facility manager may wish to provide a different baseline configuration for thermostat devices installed in common areas of a residential building (e.g., hallways, fitness room, etc.). Facility management portal 802 and the associated user interface allows users to easily and efficiently provide such configurations to groups of thermostat devices installed in one or more buildings. This functionality not only creates efficiency for building stakeholders, but it also improves the experience of tenants that occupy the building.

Interface 2300 shows an example of a device profile interface 2300 where the user has not yet created any device profiles. Interface 2400 shows a dialog box 2410 for creating a new device profile. As shown, the user may give the device profile a name, and may choose to include one or more of comfort settings, equipment settings, schedule settings, and notification settings as part of the device profile. Interface 2500 show an example of comfort settings 2510 associated with a device profile. As shown, the user may choose a temperature unit (e.g., degrees Fahrenheit or degrees Celsius), a temperature offset, temperature preferences, schedule preferences, and air quality settings. The temperature preferences may include heating and cooling temperatures associated with an occupancy schedule, a sleep time, and a wake up time. The schedule preferences may include occupancy sensing settings, arrival anticipation settings, and prestart settings. The air quality settings may include a minimum hourly runtime and a period associated with running a fan. Comfort settings associated with a device profile may also include additional settings beyond what is shown in example interface 2500.

Interface 2600 shows an example of schedule settings 2610 associated with a device profile. Schedule settings 2610 may include an occupancy schedule associated with each day of the week as well as a sleep time and a wake up time. Implementing schedule settings in this manner can result in increased energy savings without sacrificing occupant comfort. Interface 2700 shows an example of notification settings 2710 associated with a device profile. Notification settings 2710 may include air quality notifications, air filter notification, service notifications, safety notifications, and other types of notifications such as weather notifications that may be provided to users via thermostat device 800. Equipment settings that can be included in a device profile can include any settings related to HVAC equipment or other equipment such as lighting equipment. For example, equipment settings may include a brightness setting for lights, a fan status or a fan speed, a type of air used in heating or cooling, and other settings such as described above. Facility management portal 802 may receive a variety of different inputs from users through device profile interfaces such as interfaces 2400, 2500, 2600, and 2700. Through these interfaces, users may provide different device profiles to different groups of thermostat devices in a building for operation of the thermostat devices in accordance with the device profile and associated settings.

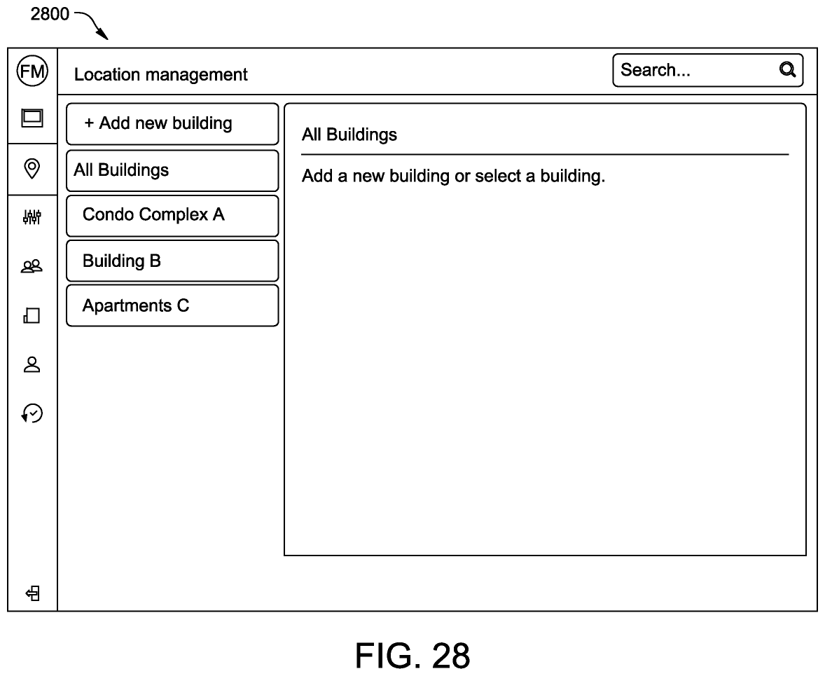

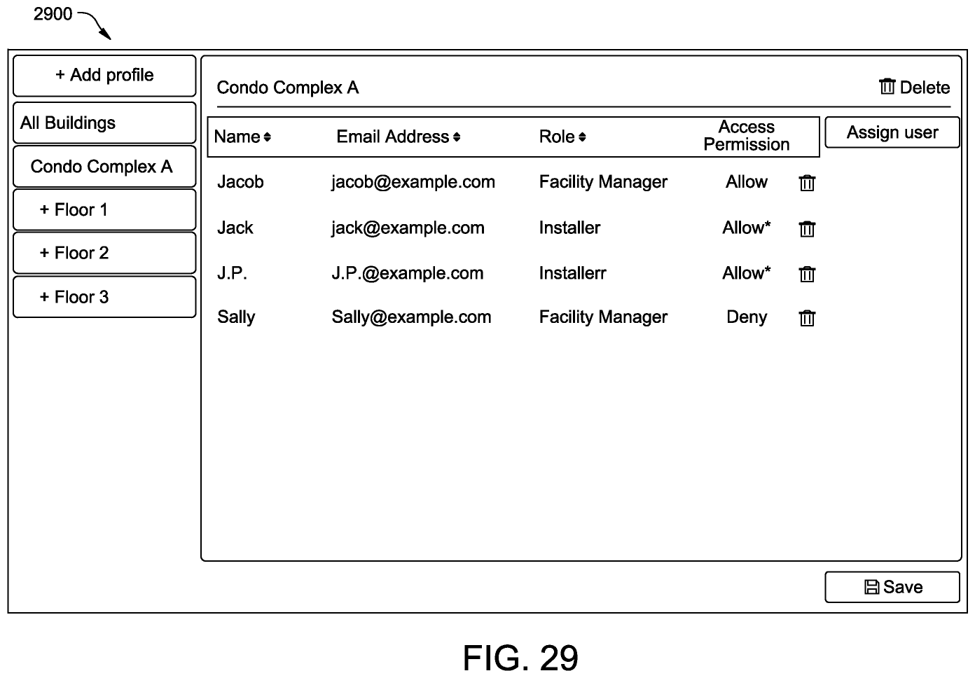

Referring now to FIGS. 28 and 29, example location management interfaces associated with facility management portal 802 are shown, according to some embodiments. The location management interfaces may generally allow users to configure space structures (e.g., floors, rooms, etc.) associated with buildings. The location management interfaces may also allow users to assign thermostat devices to building spaces and assign personnel to different building spaces (e.g., facility managers, installers, etc.). Interface 2800 shows an example spaces tree that includes three separate buildings. Users may both create new building as well as edit existing buildings through the location management interface. Interface 2900 shows a list of users assigned to assigned to the condo complex including two facility managers and two installers. As shown, some of the users may have access permission for the condo complex whereas other users may not. This access may be configured by users of facility management portal 802 such as building stakeholders and facility managers.

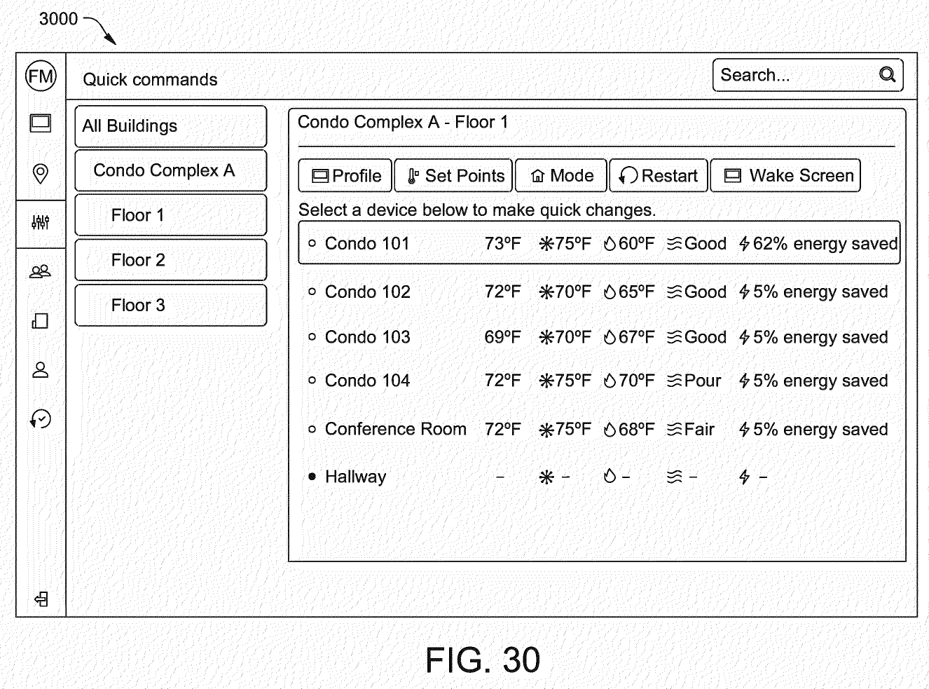

Referring now to FIG. 30, an example quick commands interface 3000 associated with facility management portal 802 is shown, according to some embodiments. Interface 3000 may include setpoints associated with thermostat device 800 such as temperature setpoints and other setpoints as described above. Interface 3000 may also allow users to manage a wake screen or screensaver associated with thermostat device 800. For example, users may upload an image that can be used as a wake screen on thermostat device 800. Interface 3000 may also allow users to make updates to a device profile and restart thermostat device 800 remotely (e.g., using the “restart” button shown in interface 3000). The user may select a single device or multiple devices at once when interacting with interface 3000. The user may also perform a remote soft reset (e.g., to reset settings of one or more selected devices) using a “reset” button displayed on interface 3000 (not shown). Further, interface 3000 may allow users to manually change a mode associated with thermostat device 800 (e.g., occupied mode, sleep mode, etc.). Facility management portal 802 may perform various actions such as changing a temperature setpoint associated with thermostat device 800 and changing a wake screen associated with thermostat device 800 based on input received from users through the quick commands interface. Users may also view information associated with devices such as energy savings, air quality, and whether the device is online or offline via interface 3000.

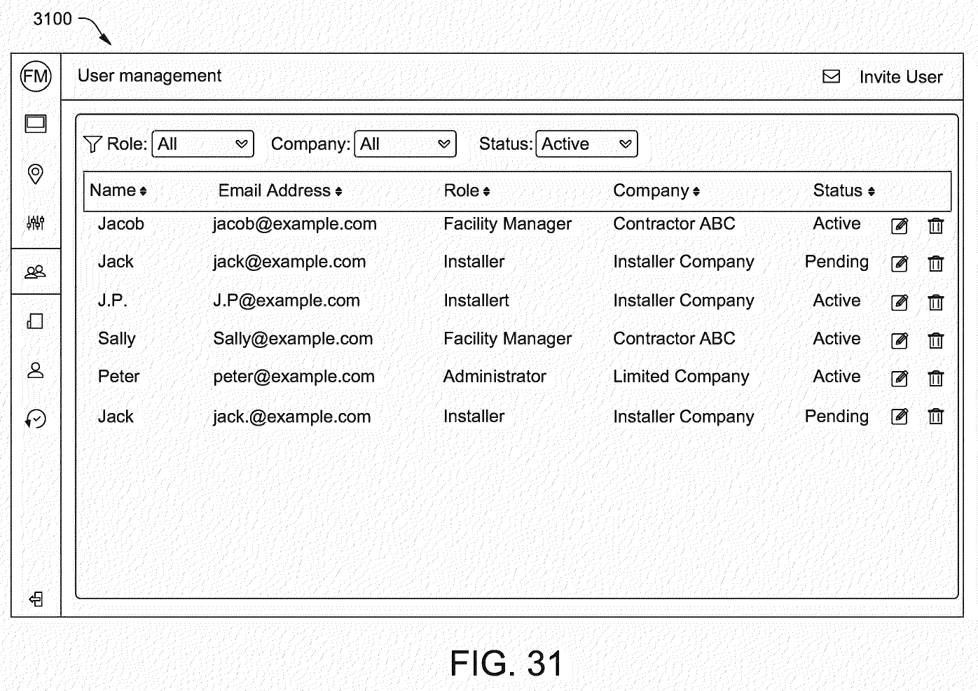

Referring now to FIG. 31, an example user management interface 3100 associated with facility management portal 802 is shown, according to some embodiments. Interface 3100 allows users of facility management portal 802 with the proper access rights to add new users or delete existing users. Interface 3100 provides users with a simple and straightforward view of how many users have access to facility management portal 802. The list of users as shown in interface 3100 can be filtered by role (e.g., facility manager, installer, etc.), building, status, and other parameters. The status of a given user may be shown as active if the user has access, pending if the user has been invited but does not yet have access, or inactive if a user does not currently have access but has not been deleted. Invites may be sent to new users through email, text message, and other types of communication.

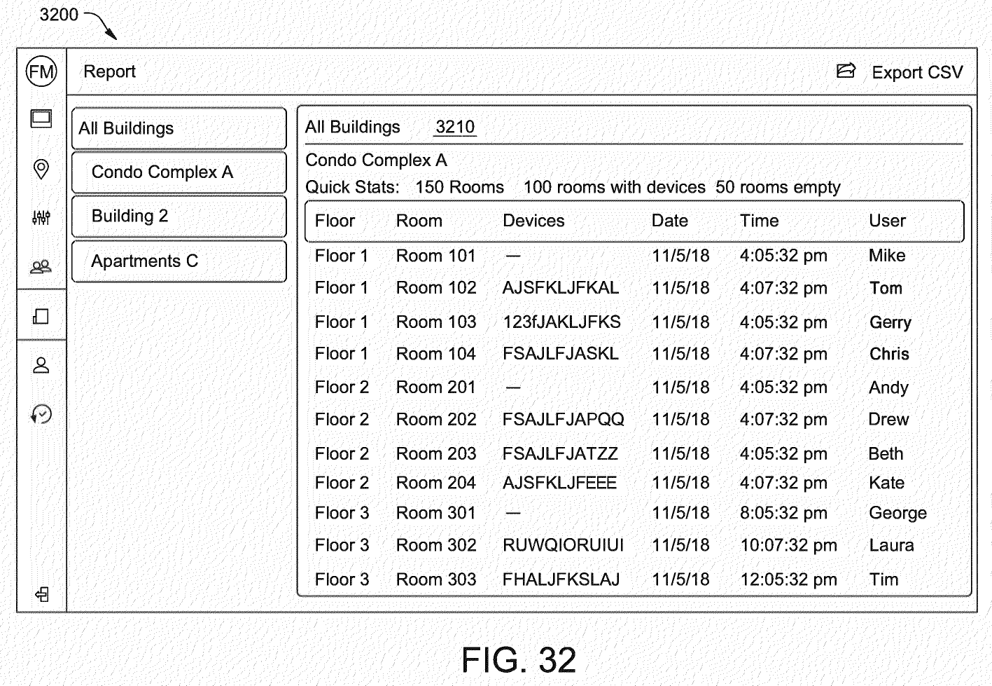

Referring now to FIG. 32, an example reporting interface 3200 associated with facility management portal 802 is shown, according to some embodiments. Facility management portal 802 can be configured to generate a report 3210 that details some or all thermostat devices installed in one or more buildings. Report 3210 may include a location associated with each device (e.g., floor, room, etc.), an identifier associated with each device (e.g., serial number), a time and date when communication with the device last occurred or a time date when a most recent update to the device occurred, a user associated with the device (e.g., tenant, installer, facility manger), and other information about each device. Further, report 3210 may provide “quick stats” such as a total number of rooms in a building, a number of rooms with a thermostat device installed therein, and a number of rooms without a thermostat device installed therein. This reporting functionality allows building stakeholders and facility mangers to easily assess inventory and may inform a variety of different decisions.

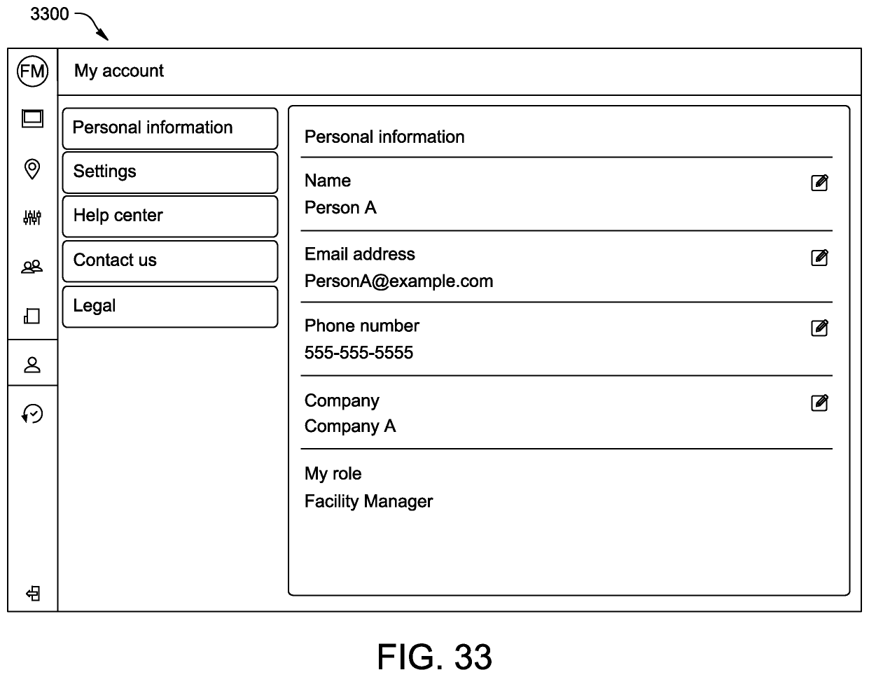

Referring now to FIG. 33, an example user account interface 3300 associated with facility management portal 802 is shown, according to some embodiments. Interface 3300 may allow users to update personal information associated with their account such as name, email address, phone number, company, and role. Further, interface 3300 may allow users to edit various settings associated with their account (e.g., change password), access a help center, contact an entity associated with facility management portal 802, and view legal information associated with facility management portal 802.

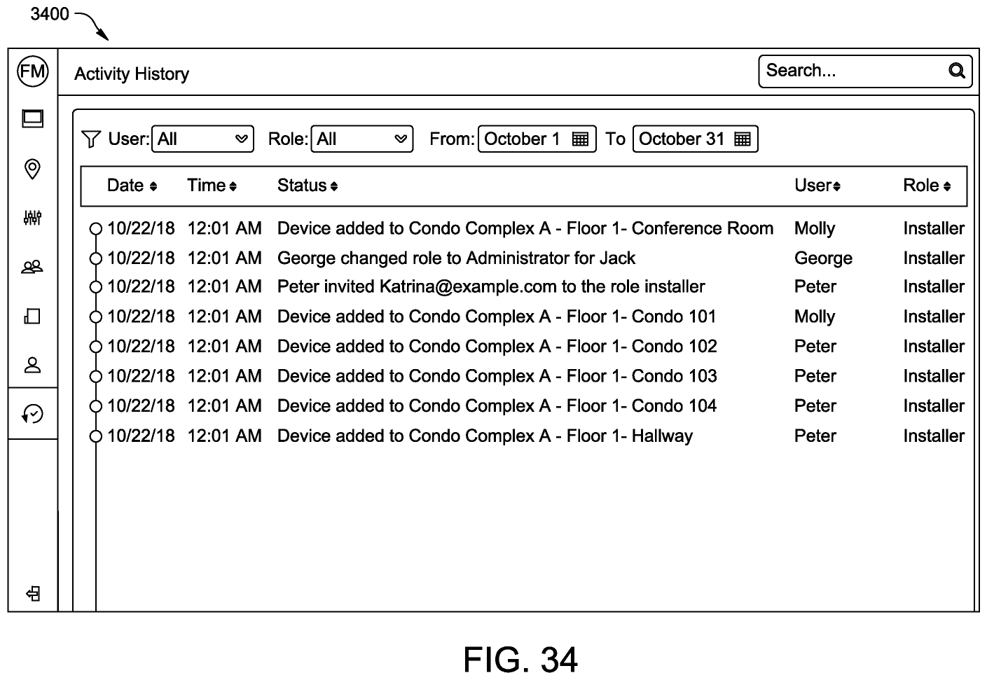

Referring now to FIG. 34, an example activity history interface 3400 associated with facility management portal 802 is shown, according to some embodiments. Interface 3400 may allow users with proper permission to view an activity log containing actions performed by various users within facility management portal 802. For example, the activity log may include new thermostat device installs, additions and removals of users, user access modifications, user role changes, and any other actions that can be performed using facility management portal 802 such as described herein. Activity logs may be filtered by user, by role, by building, by building space, and by certain date ranges, among other types of parameters. Interface 3400 allows users such as building stakeholders to easily and efficiently view activity performed using facility management portal 802. Interface 3400 and associated functionality can facilitate an easier audit process, for example, as activity logs may be easily generated and exported.

### Configuration of Exemplary Embodiments

The construction and arrangement of the systems and methods as shown in the various embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements may be reversed or otherwise varied and the nature or number of discrete elements or positions may be altered or varied. Accordingly, all such modifications are intended to be included within the scope of the present disclosure. The order or sequence of any process or method steps may be varied or re-sequenced according to alternative embodiments. Other substitutions, modifications, changes, and omissions may be made in the design, operating conditions and arrangement of the embodiments without departing from the scope of the present disclosure.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures show a specific order of method steps, the order of the steps may differ from what is depicted. Also two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

What is claimed is:

1. A system comprising:
one or more computer-readable storage media having instructions stored thereon that, when executed by one or more processors, cause the one or more processors to implement operations comprising:
presenting a user interface to a user on a user device, the user associated with a building;
displaying, on the user interface, a device profile interface comprising settings associated with a thermostat device, the settings comprising comfort settings, schedule settings, and notification settings for the thermostat device;
creating a first profile for a first group of thermostat devices installed in the building based on a first input received from the user via the device profile interface, the first profile comprising comfort settings, schedule settings, and notification settings for the first group of thermostat devices;
creating a second profile for a second group of thermostat devices installed in the building based on a second input received from the user via the device profile interface, the second profile comprising comfort settings, schedule settings, and notification settings for the second group of thermostat devices;
providing the first profile to the first group of thermostat devices installed in the building for operation of the first group of thermostat devices in accordance with the first profile; and
providing the second profile to the second group of thermostat devices installed in the building for operation of the second group of thermostat devices in accordance with the second profile.

2. The system of claim 1, wherein the building comprises a residential building, and wherein:
each thermostat device of the first group of thermostat devices comprises a thermostat device installed in a unit of the residential building, the unit associated with a tenant of the residential building; and
each thermostat device of the second group of thermostat devices comprises a thermostat device installed in a common area of the residential building.

3. The system of claim 1, wherein:
the schedule settings comprise an occupancy schedule, a sleep time, and a wake time;
the comfort settings comprise temperature settings associated with the occupancy schedule, the sleep time, and the wake time; and
the notification settings comprise air quality notification settings and air filter notification settings.

4. The system of claim 1, wherein the building comprises a first building and the user comprises a first user, the operations further comprising:
displaying, on the user interface, a location management interface comprising a space structure associated with the building, the space structure comprising floors and rooms in the building;
assigning each thermostat device of the first group of thermostat devices to one of the rooms in the building based on a third input received from the user via the location management interface;
assigning a second user to the first building based on a fourth input received from the first user via the location management interface; and
assigning a third user to a second building based on a fifth input received from the first user via the location management interface;
wherein the second user and the third user each comprise a facility manager or an installer.

5. The system of claim 1, the operations further comprising:
receiving data from each thermostat device of the first group of thermostat devices;
displaying, on the user interface, a tenant summary interface comprising the data, the data comprising daily equipment runtime data, air quality data, temperature data, and relative humidity data.

6. The system of claim 1, the operations further comprising:
receiving data from each thermostat device of the first group of thermostat devices and the second group of thermostat devices;
determining a daily equipment runtime associated with the building based on the data;
generating an air quality map associated with the building based on the data; and
displaying, on the user interface, a site overview interface comprising the daily equipment runtime and the air quality map.

7. The system of claim 1, wherein the user comprises a first user, the operations further comprising:
displaying, on the user interface, a quick commands interface comprising setpoints and a wake screen associated with a thermostat device of the first group of thermostat devices;
changing one or more of the setpoints based on a third input received from a second user via the quick commands interface, wherein the second user is a tenant of the building; and
changing the wake screen based on a fourth input received from the second user via the quick commands interface.

8. The system of claim 1, the operations further comprising:
generating a report comprising each thermostat device of the first group of thermostat devices and the second group of thermostat devices and a location in the building associated therewith; and
displaying the report to the user on the user interface.

9. A method comprising:
presenting a user interface to a user on a user device, the user associated with a building;
displaying, on the user interface, a device profile interface comprising settings associated with a thermostat device, the settings comprising comfort settings, schedule settings, and notification settings for the thermostat device;
creating a first profile for a first group of thermostat devices installed in the building based on a first input received from the user via the device profile interface, the first profile comprising comfort settings, schedule settings, and notification settings for the first group of thermostat devices;
creating a second profile for a second group of thermostat devices installed in the building based on a second input received from the user via the device profile interface, the second profile comprising comfort settings, schedule settings, and notification settings for the second group of thermostat devices;
providing the first profile to the first group of thermostat devices installed in the building for operation of the first group of thermostat devices in accordance with the first profile; and
providing the second profile to the second group of thermostat devices installed in the building for operation of the second group of thermostat devices in accordance with the second profile.

10. The method of claim 9, wherein the building comprises a residential building, and wherein:
each thermostat device of the first group of thermostat devices comprises a thermostat device installed in a unit of the residential building, the unit associated with a tenant of the residential building; and
each thermostat device of the second group of thermostat devices comprises a thermostat device installed in a common area of the residential building.

11. The method of claim 9, wherein:
the schedule settings comprise an occupancy schedule, a sleep time, and a wake time;
the comfort settings comprise temperature settings associated with the occupancy schedule, the sleep time, and the wake time; and
the notification settings comprise air quality notification settings and air filter notification settings.

12. The method of claim 9, wherein the building comprises a first building and the user comprises a first user, the method further comprising:
displaying, on the user interface, a location management interface comprising a space structure associated with the building, the space structure comprising floors and rooms in the building;
assigning each thermostat device of the first group of thermostat devices to one of the rooms in the building based on a third input received from the user via the location management interface;
assigning a second user to the first building based on a fourth input received from the first user via the location management interface; and
assigning a third user to a second building based on a fifth input received from the first user via the location management interface;
wherein the second user and the third user each comprise a facility manager or an installer.

13. The method of claim 9, further comprising:
receiving data from each thermostat device of the first group of thermostat devices;
displaying, on the user interface, a tenant summary interface comprising the data, the data comprising daily equipment runtime data, air quality data, temperature data, and relative humidity data.

14. The method of claim 9, further comprising:
receiving data from each thermostat device of the first group of thermostat devices and the second group of thermostat devices;
determining a daily equipment runtime associated with the building based on the data;
generating an air quality map associated with the building based on the data; and
displaying, on the user interface, a site overview interface comprising the daily equipment runtime and the air quality map.

15. The method of claim 9, wherein the user comprises a first user, the method further comprising:
displaying, on the user interface, a quick commands interface comprising setpoints and a wake screen associated with a thermostat device of the first group of thermostat devices;
changing one or more of the setpoints based on a third input received from a second user via the quick commands interface, wherein the second user is a tenant of the building; and
changing the wake screen based on a fourth input received from the second user via the quick commands interface.

16. The method of claim 9, wherein the user comprises a first user, the method further comprising:
displaying, on the user interface, a user management interface comprising a list of users with access to the user interface; and
adding or removing a second user from the list of users based on a third input received from the first user.

17. A method comprising:
presenting a user interface to a user on a user device;
displaying, on the user interface, a device profile interface comprising settings associated with a control device;
creating a first profile for a first group of control devices associated with a building based on a first input received from the user via the device profile interface, the first profile comprising settings for the first group of control devices;
creating a second profile for a second group of control devices associated with the building based on a second input received from the user via the device profile interface, the second profile comprising settings for the second group of control devices;
providing the first profile to the first group of control devices associated with the building for operation of the first group of control devices in accordance with the first profile; and
providing the second profile to the second group of control devices associated with the building for operation of the second group of control devices in accordance with the second profile.

18. The method of claim 17, wherein the settings for the first group of control devices comprise:
schedule settings comprising an occupancy schedule, a sleep time, and a wake time;
comfort settings comprising temperature settings associated with the occupancy schedule, the sleep time, and the wake time; and
notification settings comprising air quality notification settings and air filter notification settings.

19. The method of claim 17, wherein the building comprises a first building and the user comprises a first user, the method further comprising:
displaying, on the user interface, a location management interface comprising a space structure associated with the building, the space structure comprising floors and rooms in the building;
assigning each control device of the first group of control devices to one of the rooms in the building based on a third input received from the user via the location management interface;
assigning a second user to the first building based on a fourth input received from the first user via the location management interface; and
assigning a third user to a second building based on a fifth input received from the first user via the location management interface;
wherein the second user and the third user each comprise a facility manager or an installer.

20. The method of claim 17, further comprising:
receiving data from each control device of the first group of control devices and the second group of control devices;
determining a daily equipment runtime associated with the building based on the data;
generating an air quality map associated with the building based on the data; and
displaying, on the user interface, a site overview interface comprising the daily equipment runtime and the air quality map.
